(19) United States
(12) Patent Application Publication
(10) Pub. No.: US 2001/0032312 A1
(43) Pub. Date: Oct. 18, 2001

(54) System and method for secure electronic digital rights management, secure transaction management and content distribution

(76) Inventors: Davor Runje, Zagreb (HR); Mario Kovac, Zagreb (HR); Brian D. Litman, West Hollywood, CA (US); Josko Orsulic, Zagreb (HR); Tomislav Uzelac, Zagreb (HR)

Correspondence Address: Norton R. Townsley, Suite 330, 100 Corporate Pointe, Culver City, CA, 90230, US

(21) Appl. No.: 09/728,658

(22) Filed: Dec. 1, 2000

Related U.S. Application Data
(60) Provisional application No. 60/186,983, filed on Mar. 6, 2000.

(51) Int. Cl. G06F 12/14; H04L 9/32

(52) U.S. Cl. 713/172; 705/52

(57) ABSTRACT

System and method for secure electronic rights management, secure transaction management and content distribution. This invention ensures that content can be used or experienced by the end user only if an appropriate license has been obtained. Content owners prepare content for release in the system and make it available in electronic or physical form. Prior to purchase of the license, the user sends an offer request to the system. The system replies by providing all possible offers (or selected offers based on predefined criteria) through which the license can be purchased. Each offer represents a path from the content owner to the terminal. By selecting one path, the user initiates the license request process. Upon execution of the transaction, the license is securely stored within the user's personal license management device. The user's personal usage device communicates with the user's license management device so that only licensed content can be used/experienced.

### CROSS REFERENCE

The Applicants claim the benefit of their Provisional Application, Ser. No. 60/186,983 filed Dec. 3, 1999.

### BACKGROUND OF THE INVENTION

1. Field of the Invention

This invention relates to systems and methods for rights management and efficient distribution of the content such as audio, video and other types of multimedia, electronic files, consumer electronic devices, and other. It also relates to systems for handling existing and future business and distribution models.

2. Description of the Related Art

Today, the music industry is suffering big financial losses because of CD piracy and rapidly increasing loss because of MP3¹ piracy. This is due to the low cost of copying CDs with a CD-R recorder and a computer. CDnow is the leading Internet music store in terms of total revenue. It was started in a founder's basement and had $6 million in sales in 1996. The biggest threat, however, comes from highly organized pirates that “press”, distribute and sell illegal CDs. Individuals encoding their CDs and exchanging compressed music in MP3 format constitute a lesser threat than specialized sites with MP3 archives and search engines that provide unlimited access to anyone who has access to Internet. ¹MP3 is short for MPEG layer-3 standard. It is an audio compression algorithm standardized by ISO.

The only thing that is slowing down the expansion of MP3 underground² at this point is a lack of ability on the pirate's side to collect money for their services. Unlike their analogues from the physical world (pressed CDs), MP3 files can not easily be sold in order make money from illegal activities. This results in MP3 sites being modestly maintained and with slow connection. ²MP3 underground is a term for people that encode music from CDs and distribute it over the Internet.

This is about to change in immediate future. Users are becoming more familiar with Internet based commerce. Solutions for online payments are becoming more mature and are in use today. This enables MP3 sites to start their business by providing access to subscribed users only. Numerous sites provide not only pirated MP3 files, but also charts and genre oriented categorizations. There are search engines that search the Internet for MP3 files. This approach has already proved to be successful by adult sites that have up to 100,000 subscribers and charge about $10 a month. It is clear that sites with music will attract far more attention than these specific sites and possibly create losses for the music industry.

Development of a system and method for secure electronic rights management, secure transaction management and secure content distribution which can restrict use/experience of content to ends user who have obtained appropriate licenses represents a great improvement in the field of copyright management and distribution and satisfies a long felt need of the copyright holder.

### SUMMARY OF THE INVENTION

It is the object of invention to provide a system and method for secure electronic rights management, secure transaction management and secure content distribution. This invention enables content to be used or experienced by the end user only if an appropriate license has been previously obtained. This invention allows existing distribution models to be directly mapped into the system and expanded by adding higher levels of functionality and usability. The system consists of back-end entities that ensure proper operation of the system functions, and other nodes (such as content owners, distributors, etc).

The preferred embodiment of the system requires Secure Environment (SecEnv) and Secure Device (SecDev). The system allows for several levels of security for both SecEnv and SecDev as defined in Security levels description. Example Security levels that are defined in the system are:

non-secure

software (SW) secured—(security built into SW package) level I: i.e. software contains certain IDs or crypto keys used for identification and/or encryption,decryption

SW secured level II—(hardware provides some identification information that is used by the SW) software reads EDs or crypto keys from the hardware device

Embedded level I—software is placed inside the embedded processor and this software contains certain IDs or crypto keys used for identification and/or encryption,decryption

Embedded level II—software is placed inside the embedded processor and software reads IDs or crypto keys from the protected storage inside the embedded processor

Secure chip level—software, IDs and keys are all stored within protected storage inside the embedded processor. Execution environment is tamper proof (nothing can be read out, changed, etc.). Example is a “Smartcard”.

These can be further defined, modified and refined, based on various properties of the application and hardware platforms.

SecEnv is defined as a secure and controlled environment (e.g. a secure computer in a secure building) where highly secure actions are performed and where the probability of illegal penetration is smaller then the one defined in the specified security level. One example of SecEnv is the Secure Device personalization location. The Secure Device personalization location is the production site where the KeyCards are personalized (specific IDs and keys are stored within them). This is a high-risk process that must be strictly controlled.

SecDev is similarly defined as a device that stores privileged data and/or performs privileged (secure) actions and where the probability that someone can illegally obtain privileged data and/or illegally perform a privileged action is smaller then the one defined in the specified security level. One preferred example of a SecDev used in this invention is a Smart Card/Smart Chip device.

Content Owners (COs) are entities providing content to the system. They own the content in its original form(s). This invention allows for electronic and physical content (goods) or other content type (e.g. service). Example content types can be defined as:

i) Digital content, complete version, unprotected

ii) Digital content, complete version, protected

iii) Digital content, reduced version, unprotected

iv) Digital content, reduced version, protected

v) Non-digital content, complete version, unprotected

vi) Non-digital content, complete version, protected

vii) Non-digital content, reduced version, unprotected

viii) Non-digital content, reduced version, protected

Hence, content could be: high quality audio, high/medium/low quality video, cable channel subscription, newspaper and many others. Based on the type of the content, Content Owners may (or may not) transform/modify the content before releasing it into the system. This transformation/modification can have several purposes one of which could be to protect the original content so that it cannot be experienced/used without the proper license from the Content Owner. An example of this transform is compression, encryption and encoding of a digital audio file. Content Owners may also release content not transformed/modified, where other types of usage license may be defined. Content Owners also define highest hierarchical level of business rules for content they provide to the system and manage extensions to those rules created by other system nodes.

System Terminals are system nodes that act as an interface between users and the system. System Terminals enable transfer of data, content and/or licenses between system nodes and users. System terminals also allow browsing and searching of content offered by the system. Very simplified, one can see System Terminals as a combined retail store, ATM and search engine.

Information about the content and content related identification (Content Reference) is spread using promotional activities. This reference can be stored in the “Shopping basket” of the License Management Device (LMD) to be used as a reference during license purchase activities or content retrieval activities. The preferred method for storing of this information to the LMD is e.g. a “Like” pushbutton on the consumer electronic device that extracts reference from stream being played or side channel and stores it in LMD. Other approaches can also be used and have the same function.

Prior to purchase of the license, a user sends an offer request to the system. The system replies by providing all possible offers (or selected offers based on predefined criteria) through which the license can be purchased. Each offer represents a path from the content owner to the terminal. The invention allows for free and dynamic creation of paths where each node (entity) can create it's own set of business models. By selecting one path (e.g. path with minimal price), the user initiates the license request process. Upon execution of the transaction, the license is securely stored within License Management Device. The Usage Device (UD) communicates with the License Management Device that controls if the content can be used or not. The current invention allows for certain nodes to be merged together, if desired. For example, UD and LMD can be physically implemented as a single device.

Examples of system transactions.

A simplified example of usage of current invention is as follows. Content Owner introduces new protected content, in this example a new song, to the system and markets it's existence on the radio. A user listens the song while jogging and pushes the ‘Like’ button on his GSM phone/radio/music player so that information about the song is stored within the device. After coming home, the user connects to the system network using his phone (the GSM service provider acts as a System Terminal) and obtains an offer response on the screen of his GSM phone. After selecting the desired license (for example an unlimited license) he initiates purchase transaction. The system processes this transaction and returns the requested license to be stored on the License Management Device. The user can now listen the song. In this case, since he purchased an unlimited license, he can listen to the song as many times as he wants.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a block diagram providing an overview of the system according to this invention.

FIG. 2 is a block diagram illustrating system initialization.

FIG. 3 is a block diagram illustrating system entity management.

FIG. 4 is a block diagram illustrating system operation.

FIG. 5 is a block diagram illustrating Certificate Authority creation.

FIG. 6 is a block diagram illustrating Transaction Authority creation.

FIG. 7 is a block diagram illustrating certificate generation

FIG. 8 is a block diagram illustrating generation of a unique identification

FIG. 9 is a block diagram illustrating generation of private and public keys

FIG. 10 is a block diagram illustrating generation of Financial Clearance authority (FC)

FIG. 11 is a block diagram illustrating Content Owner (CO) creation.

FIG. 12 is a block diagram illustrating generation of a default business rule and insertion in the Business Rule Data Base (BRDB).

FIG. 13 is a block diagram illustrating exposure source creation

FIG. 14 is a block diagram illustrating usage device creation

FIG. 15 is a block diagram illustrating distribution creation.

FIG. 16 is a block diagram illustrating terminal creation

FIG. 17 is a block diagram illustrating License Management Device (LMD) creation.

FIG. 18 is a block diagram illustrating content preparation.

FIG. 19 is a block diagram illustrating generation of unique content identifier.

FIG. 20 is a block diagram illustrating generation and storage of a FAT_HEADER.

FIG. 21 is a block diagram illustrating content encoding.

FIG. 22 is a block diagram illustrating content distribution flow.

FIG. 23 is a block diagram illustrating the content distribution process

FIG. 24 is a block diagram illustrating distributor content processing.

FIG. 25 is a block diagram illustrating adding a business rule into BRDB

FIG. 26 is a block diagram illustrating generation of the DIST_HEADER.

FIG. 27 is a block diagram illustrating exp. source content processing.

FIG. 28 is a block diagram illustrating generation of the EXP_HEADER.

FIG. 29 is a block diagram illustrating purchase of a licence.

FIG. 30 is a block diagram illustrating putting SHOPPING_INFO into LMD.

FIG. 31 is a block diagram illustrating processing of SHOPPING_REQ

FIG. 32 is a block diagram illustrating requesting an offer

FIG. 33 is a block diagram illustrating TA processing of OFFER_REQ.

FIG. 34 is a block diagram illustrating Business Rule Data Base Manager (BRDBMGR) processing of OFFER_REQ

FIG. 35 is a block diagram illustrating generation of an offer

FIG. 36 is a block diagram illustrating user processing of OFFER_REQ.

FIG. 37 is a block diagram illustrating offer payment.

FIG. 38 is a block diagram illustrating license retrieval.

FIG. 39 is a block diagram illustrating license request creation

FIG. 40 is a block diagram illustrating Transaction Authority processing of the license request.

FIG. 41 is a block diagram illustrating Content Owner processing of LICENSE_REQ.

FIG. 42 is a block diagram illustrating LMD processing of LICENSE_REQ.

FIG. 43 is a block diagram illustrating content usage

FIG. 44 is a block diagram illustrating LMD processing of USAGE_REQ.

FIG. 45 is a block diagram illustrating LMD usage of content

FIG. 46 is a block diagram illustrating licence management device—usage device communication requirements.

FIGS. 47-51 are examples of UDs that are enabled to utilize this system.

FIG. 47 illustrates a combination CD player and radio (a “boom box”).

FIG. 48 illustrates a car radio.

FIG. 49 illustrates a GSM enabled phone.

FIG. 50 illustrates a TV set with a remote control.

FIG. 51 illustrates a set top TV control box, as would be used with cable or satellite TV, with a remote control.

### DETAILED DESCRIPTION OF THE PREFERRED EMBODIMENT

Introduction

This invention is an integrated, modular, fully interchangeable globally scalable e-commerce architecture for the secure and trusted connection of buyers (individuals) and sellers (e.g record companies, artists, movie studios) of digital content (e.g. music, videos). With This invention, secure digital content can be distributed via traditional CD and made accessible to the user via inexpensive authorization systems akin to the credit card swipers found at merchants worldwide. With this invention, on a track by track basis, or album by album basis (or any combination thereof) the owners of the copyrights can take their libraries and compile, decompile, make albums and collections, discount and bundle, give-away or otherwise create every conceivable commercial usage of their digital assets.

With this invention, copyright holders are able to licence rights to end-users based on specific and time-based “permissions” which define when and how the end-user will enjoy the content in question. The ability for copyright owners to fully control usage of their copyrights and the fact that they never cede ownership is key to this invention's attractiveness.

Before content is integrated with the system, it must first be prepared for distribution. This is done by taking the original digital form and encoding and watermarking it to add the necessary security, authentication and tracking characteristics. When an individual orders the System to serve them up content, it is then encrypted by this process which will personalize the content only to one individual user and no one else.

The current preferred compression and decompression software is Advanced Audio Codec (AAC) licensed by Dolby Laboratories. However, the modular nature of this invention will allow for the change of such software as superior ones may appear. Of course, backward compatibility will be engineered-in.

At the heart of the infrastructure of this invention is a sophisticated piece of software called the Secure Transaction Server (STS) which is housed at one or more interconnected secure transaction centers around the world. STS will perform the following functions:

1) Authentication of Users

2) Authentication of Record Company Servers on the System

3) Cryptographic Services

4) Management of financial transactions

5) Copyright Management and Reporting

6) Sample File Management and Reporting

7) Anti-Piracy and Anti-Copy system management and

8) Authorized User Control and Unauthorized User prevention

In short, the STS monitors each transaction on the network. The STS is a trusted third party system. Therefore it will likely involve the participation of another party to audit and verify compliance such as one of the major accounting firms.

Using and enjoying this invention is simple and extremely secure. There are 3 principal elements to this invention:

A. A KeyCard containing digital licenses. Preferably, it is the size of a credit card but with a microchip inside. When a user registers with the system for the first time, they will receive in the mail (or at a checkout counter) their KeyCard. To activate their key, the user inserts it into a special terminal and inputs a PIN. The user always keeps they key with them. The KeyCard is embedded with next-generation “digital cash” or dollar credits that the user can use to pay for new licenses.

B. A storage medium containing encrypted and watermarked content. The content files are secured using near military-grade cryptography. One storage medium is smart media or memory cards which are removable and interchangeable with any playback device compatible with this invention. Another storage medium is CDs or higher density DVDs.

C. A portable or fixed-position playback device.

Usage simply require inserting items “A” and “B” into item “C”. The result is a flexible and secure system. This invention is so powerful that it can enable each user to access any and all the content they wish, provided that this content is on the network and they have paid for the rights.

The KeyCard contains all of the information that the system needs to know about the user. With the KeyCard users will be able to search the entire database of available content that they can be issued to rights to enjoy on the network. This database will be a combination of the respective databases maintained by the owners of the copyrighted material in question. Since the database is based on a common database structure, all of the content that the copyright holders wish to make available will be searchable. The database is housed at the Secure Transaction Server Center.

The KeyCard is based upon term and conditional access or “permission sets”. The KeyCard recognizes what content each registrant is eligible to experience. For example, if the content is a song, the KeyCard knows, song by song, how many times the user can listen to that song. If the user purchased the song for 100 listens, then with each play of the song, the software incrementally decreases the permitted experiences. Each time a song that was previously licensed is utilized, the KeyCard remembers exactly what song was listened to and uploads this data each time the user's account is accessed using the KeyCard. If the user purchased unlimited listens, then they have just that. Users can recharge their keys, swap licenses, etc.

This precision information alone is of enormous strategic and tactical marketing value to a copyright holder. The potential for targeting new music to an individual is greatly enhanced with this kind of user information. Recommendations could be sent, with the permission of the registrant, by email in the form of an FM-quality sample file.

And what if the KeyCard is lost? When a KeyCard is updated at a network terminal, as with an ATM-card, the user must key-in their PIN. If after several tries, the PIN does not correspond, that KeyCard is immediately disabled. Also, if a KeyCard has already been reported lost or stolen, and is inserted in a Terminal, it is immediately neutralized. Therefore, without knowing the PIN a lost KeyCard is worthless to any finder.

Since the the Secure Transaction Server knows exactly what each KeyCard contains in the way of licenses, a lost KeyCard can be easily replicated with proper identification at any Terminal location or online at home using a KeyCard PC Terminal.

The storage device may contain the entire Beatles catalog, but the user, may wish only purchase permissions to access the tracks of “The White Album” for the time being. But at any point in the future, the user could add or delete their permissions to access all of those Beatles tracks with the appropriate payment.

Again, and as with the KeyCard, if a storage medium is lost the encrypted content it holds is unusable and useless to the finder. Only a user who has the proper KeyCard and storage medium combination may unlock the content contained therein.

As previously stated, the KeyCard will also hold digital cash and could likely have a dual GSM cellphone function. This fits with predictions of unified portable devices that are PDA's, cellphones and music players all-in-one.

Devices compatible with this invention include components consumers are already accustomed to. Home stereos, portable players, e-books and car radios. In addition, this invention uniquely adds the following: PC's, cable and satellite TV, hotel and cruise ship in-room systems, airline and bus in-seat entertainment consoles and even next-generation cellphones.

When a customer hears or sees some content they like they can use a point-of-purchase displays and convenient terminals to immediately purchase a license to that content.

Users are able to register online via their PCs for a KeyCard, which can be sent to them by mail. Registrants on the the network are able to both add and update licenses onto their KeyCard at home by using an inexpensive card reader/writer that will connect to a PC port.

Users can also download content via the Internet and store them on their hard drives. Besides the secure content, a single unified “download” provides the ISRC/ISWC code (rights owner information in the International format), artist data, artwork, lyrics, liner notes, bios, touring information, special merchandising offers, coupons, etc., a partial or full-length, low-quality music sample and any other related data the Copyright Holder wishes to provide.

If the user has a PC equipped with a CD-burner, they can create their own compilations from their master library of secure content files. Recall that since these tracks can only be used by the intended recipient with a KeyCard containing the license for that content. Without the key, the CD will not yield music. It will be completely useless.

With music content, for example, this invention can be engineered to allow, on a track by track basis, whether or not that particular track can be played back on the PC in CD-quality or if playback may only occur in secure mode via a compatible portable or fixed playback device.

This invention also provides for a downloadable content playing application. The content player will have a built in application application which allows invention users to send the low quality sample files via e-mail.

There are millions of consumers who are and will continue to be PC-phobic. This invention has been specifically designed to integrate into next-generation TV, set-top boxes. This invention will allow cable and satellite TV to deeply participate in secure content distribution via high-speed modems or traditional VBI technologies.

The same well engineered and compact terminals which can authorize KeyCards at retail terminals will also be depolyed on aircraft. As “Smart Card” technology is increasingly used for many other transactions, the likelihood of such terminals being placed in new aircraft increases.

Users will be able to purchase new licenses from the armrest into their KeyCard and secondly, to access special selections of content only available to KeyCard holders.

Because of this invention's forward-thinking system architecture, anywhere that a person can access a terminal which can read/write to a Smart Card and can be interconnected to the invention network they can add or modify their library of network content licenses. Consequently, a network of information kiosks is expected to proliferate.

Preferred Programming Scheme

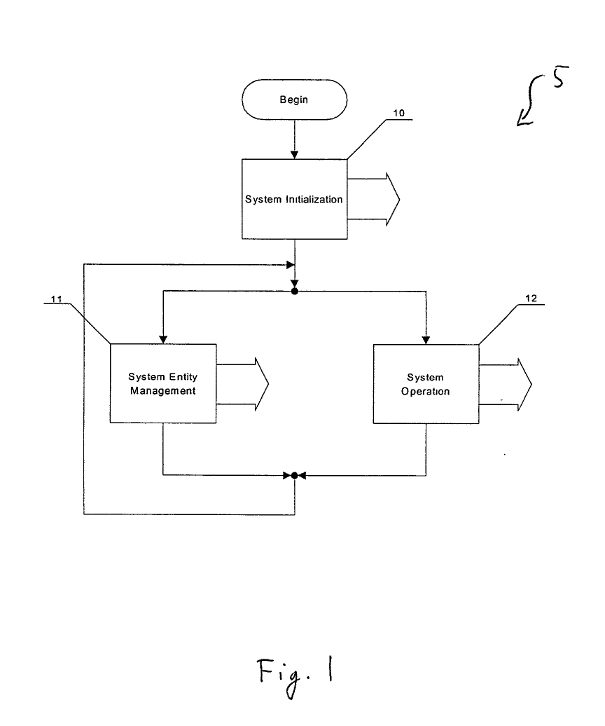

FIG. 1 shows an embodiment of the present invention 5 in block diagram form. This system 5 includes three basic processes: initialization of basic system components 10, management of other system entities 11 and operation of the system 12.

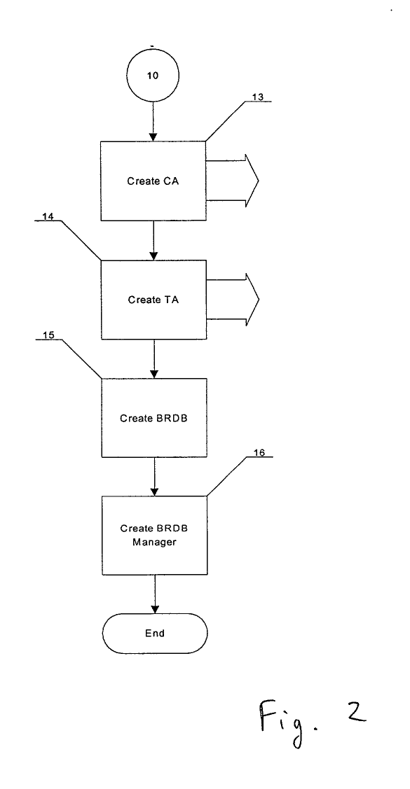

FIG. 2 provides a closer look at system initialization 10. Within this sub process, two basic system entities are created: Certificate Authority (CA) 13 and Transaction Authority (TA) 14. Auxiliary support entities of Business Rule Database Manager (BRDBMGR) 16 and Business Rule Database (BRDB) 15 itself are also created during system initialization.

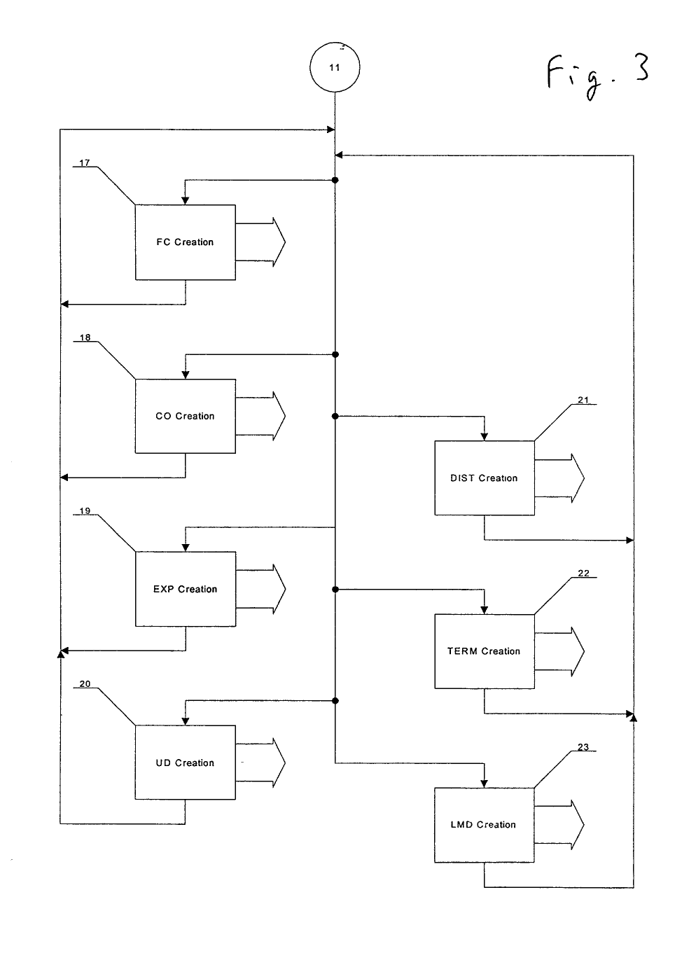

Shown in FIG. 3 is the process of creation of other system entities: Financial Clearance authority (FC) 17, Content Owner (CO) 18, Exposure Source (EXP) 19, Usage Device (UD) 20, Distributor (DIST) 21, Terminal (TERM) 22 and License Management Device (LMD) 23. The Exposure Source exposes users to content through digital or analog subchannel by means of physical distribution (CDs), broadcast, streaming or download of integral content of reference to content (DIST_HEADER).

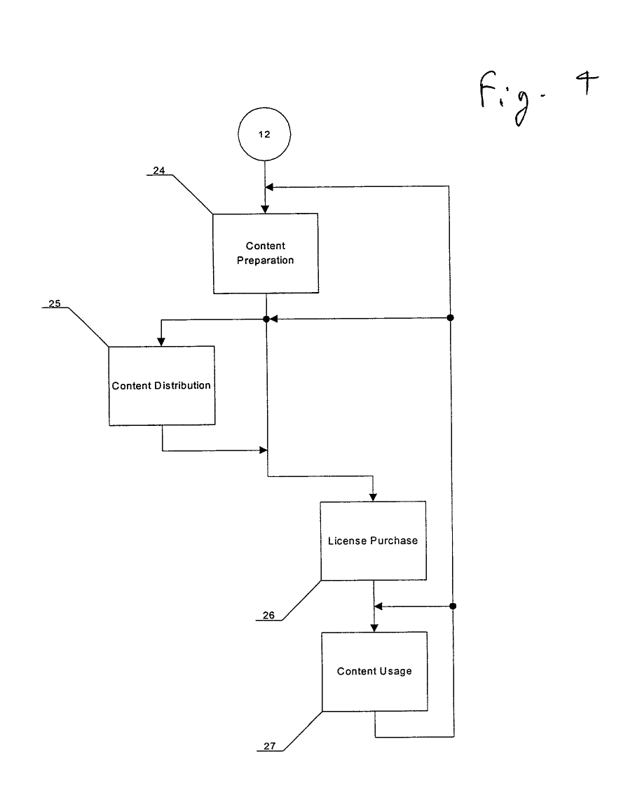

FIG. 4 shows system operation 12 divided into several sub processes: preparation of content 24, distribution of prepared content 25, purchase of user licenses 26 and finally usage of licensed content 27.

System Initialization

Before detailed explanation of sub processes 13, 14, 17, 18, 19, 20, 21, 22 and 23, some basic building blocks of these creation processes have to be defined.

Generating keys (28)

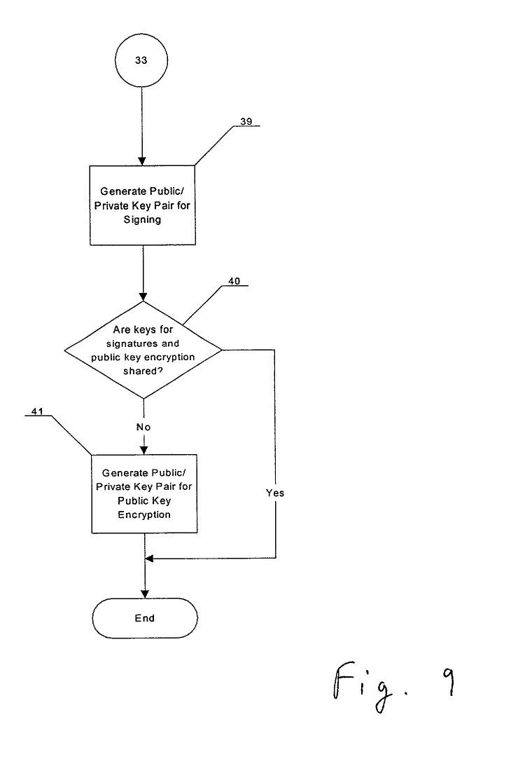

FIG. 9 shows the process of generating two pairs of asymmetric keys within SecEnv.

First, a pair of keys, SigKeyCard and VerKeyCard, is generated 39 for chosen digital signature algorithm such as DSS, RSA, ECC or other. Second, a pair of keys, DecKeyCard and EncKeyCard, is generated 41 for chosen public key encryption algorithm such as ElGamal, RSA, ECC or other. For certain algorithms such as RSA, signature and encryption key pairs may be shared 40.

Two kinds of public key algorithms are used:

a) Digital signature algorithms. These attach a piece of additional digital data (signature) to an original document that links this document and person that signs it. Two keys are generated: one for signing digital data (called signature key, abbreviation SigKey) and one for verification of that signature (verifying key, abbreviation VerKey). In the key generation process, both keys are generated in the same time. VerKeyCard is public, because its purpose is to allow anyone to verify signature. SigKeyCard is private so only its holder can sign data.

b) Public key encryption algorithms. These are used to encrypt (scramble) data so only the holder of the appropriate decryption key can decrypt the data. Two keys are generated: one for data encryption (encryption key, abbreviation EncKey) and one for data decryption (decryption key, abbreviation DecKey). In the key generation process, both keys are generated at the same time. EncKey is public, because its purpose is to allow anyone to encrypt data. Decryption key is private because only its holder is allowed to read (decrypt) messages encrypted for him/her.

Algorithms:

RSA—both public key encryption and digital signature algorithm

ElGamal—public key encryption algorithm

DSA (DSS)—digital signature algorithm

ECC—Elliptic Curve Cryptography—both public key encryption and digital signature algorithm

Two private keys SigKey and DecKey must be stored within entity's SecDev and should not be known to other system nodes. Two public keys VerKey and EncKey are made available to other system nodes.

Note: in this document SigKey, VerKey, DecKey and EncKey are private signing keys, public verifying key, private decrypting key and public encrypting key. A prefix like CA, CO, etc. means that appropriate key belongs to CA, CO, etc.

CA Creation (13)

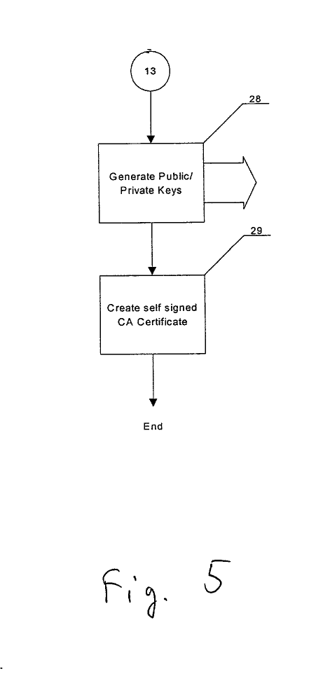

Certificate Authority is the primary system entity and it is created within SecEnv (see FIG. 5). First, as stated above, two key pairs 28 are created. The first pair of keys is CASigKey and CAVerKey. These keys are used during the later process of creation of other system nodes and serve the purpose of certification and verification of identity of these nodes. Second pair of keys, CADecKey and CAEncKey, is generated for chosen public key encryption algorithm such as ElGamal, RSA, ECC or other. It is used for public key encryption and together with the first key pair is used to establish and ensure secure communication connection/secure communication channel between CA and other system nodes. If certain algorithms such as RSA are used, signature and encryption key pairs may be shared. Two private keys CASigKey and CADecKey must be stored within CA SecDev and should not be known to other system nodes. Two public keys CA VerKey and CAEncKey must be present in all other system nodes.

CA creation process 13 ends with the creation of self signed CA certificate 29. This certificate is self-signed because CA is the top-level authority used for certification of identities of other system entities.

Certificates (30)

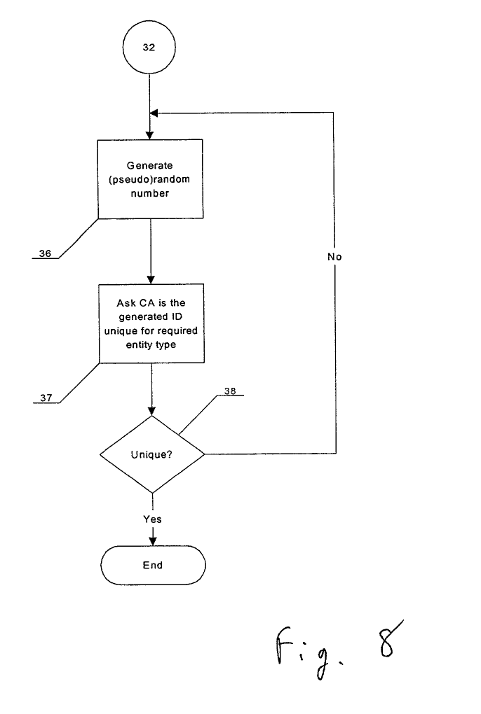

Every system entity has a unique identifier within its entity type, and the process of its generation is described in FIG. 8. Again, within SecEnv, a unique identifier (e.g. pseudo random number) is created 36. With the help of CA, the uniqueness of this identifier for each given entity type is verified 37, 38.

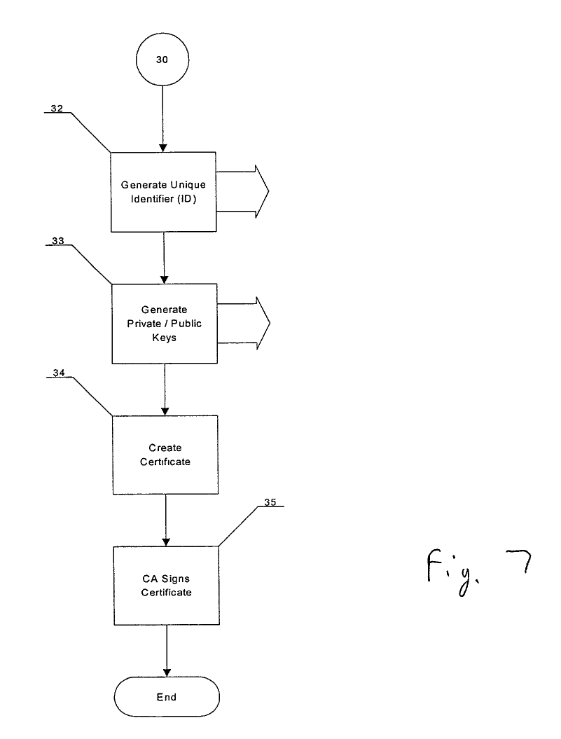

Following a successful generation of entity identifier 32, and generation of private/public key pairs 33 (see FIG. 9), an entity certificate is created 34(see FIG. 7). The certificate of every system entity consists of: entity type identifier, entity identifier, verification key, encryption key and entity's security level. This data structure is then forwarded (in secure fashion) to the CA, and the process of certificate generation 30 is completed after the CA signs the certificate 35. All certificates are made available to other system entities.

TA Creation (14)

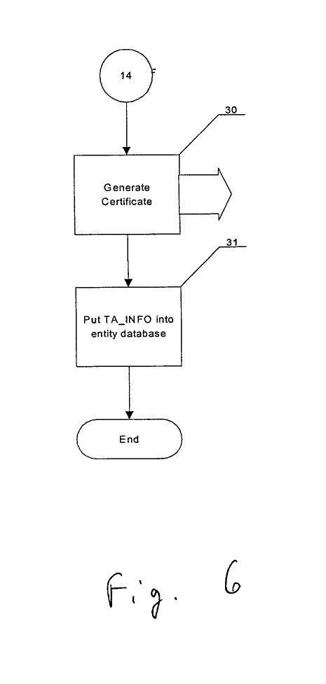

Transaction authority (TA) entity is created 14 within SecEnv. See FIG. 6. First, an entity certificate is generated 30, as described previously. After that, TA_INFO data structure is added 31 to the entity database. This structure consists of entity certificate, its network address and possibly other relevant information.

FC Creation (17)

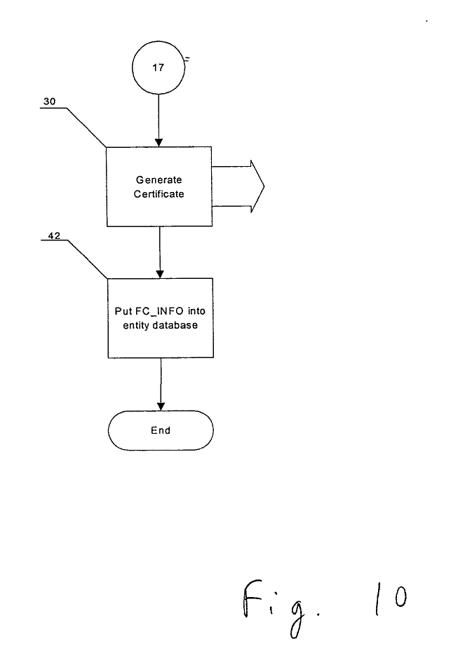

Financial clearance authority (FC) entity is created 17 within SecEnv. See FIG. 10. First, an entity certificate is generated 30, as described previously. After that, FC_INFO data structure is added 42 to the entity database. This structure consists of entity certificate, its network address, business information (such as bank account numbers) and possibly other relevant information.

System Entity Management

CO Creation (18)

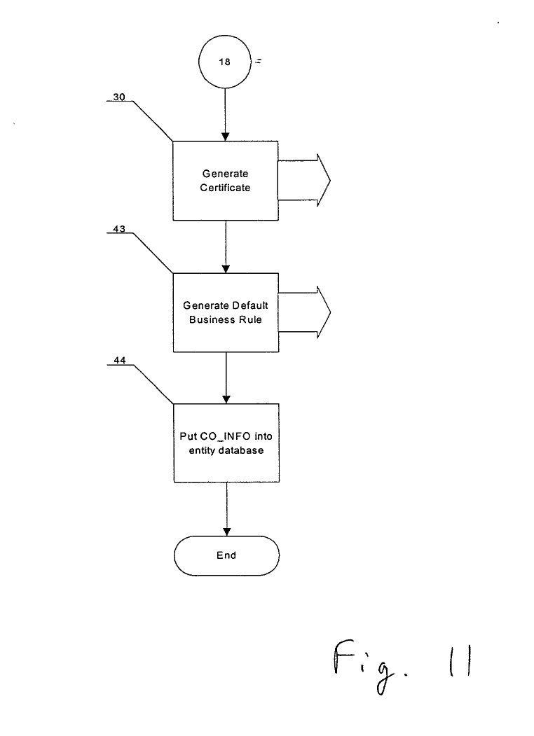

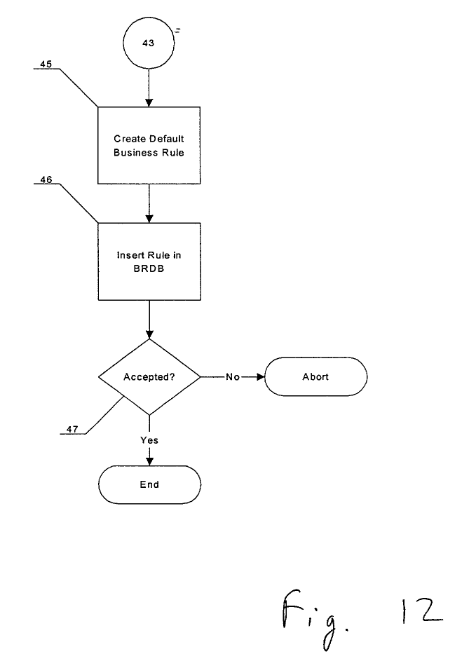

Content owner (CO) entity is created 18 within SecEnv. See FIG. 11. First, an entity certificate is generated 30, as described previously. The default Business Rule of this particular content owner is generated 43. The content owner creates 45 this Business Rule in accordance with its business policy, and forwards it 46, 47 (see FIG. 12) to the Business Rule Database Manager (BRDM) for verification and insertion into the Business Rule Database (BRD). After that, CO_INFO data structure is added 44 to the Entity Database (ED). This structure consists of the entity certificate, its network address, business information (such as bank account numbers) and possibly other relevant information.

EXP Creation (19)

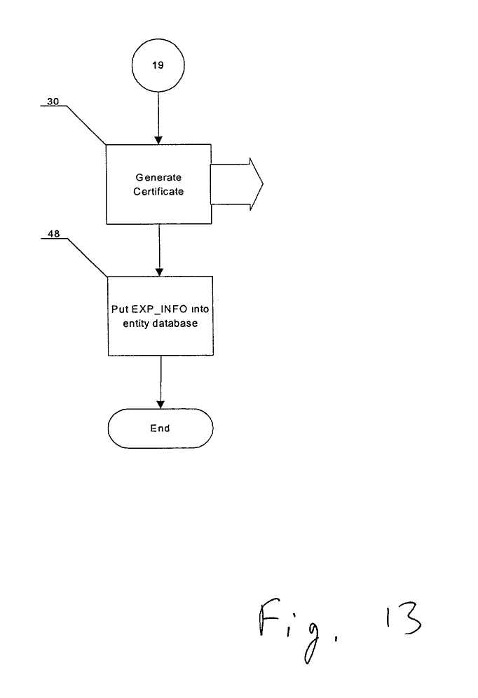

Exposure source (EXP) entity is created 21 within SecEnv. See FIG. 13. First, an entity certificate is generated 30, as described previously. After that, EXP_INFO data structure is added 48 to the Entity Database. This structure consists of the entity certificate, its network address, business information (such as bank account numbers) and possibly other relevant information.

UD Creation (20)

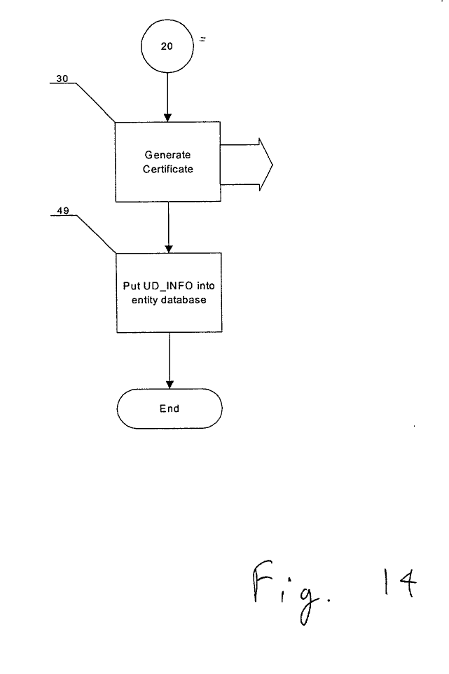

Usage Device (UD) entity is created 20 within SecEnv. See FIG. 14. First, an entity certificate is generated 30, as described previously. After that, UD_INFO data structure is added 49 to the entity database. This structure consists of the entity certificate, its manufacturer information and possibly other relevant information.

DIST Creation (21)

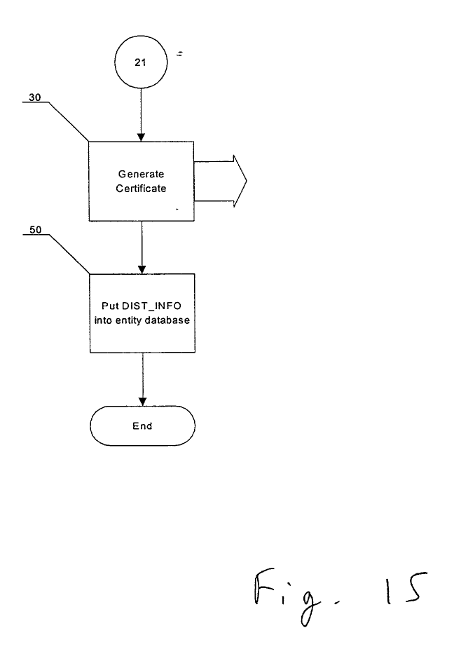

Distributor (DIST) entity is created 21 within SecEnv. See FIG. 15. First, an entity certificate is generated 30, as described previously. After that, DIST_INFO data structure is added 50 to the entity database. This structure consists of entity certificate, its network address, business information (such as bank account numbers) and possibly other relevant information.

TERM Creation (22)

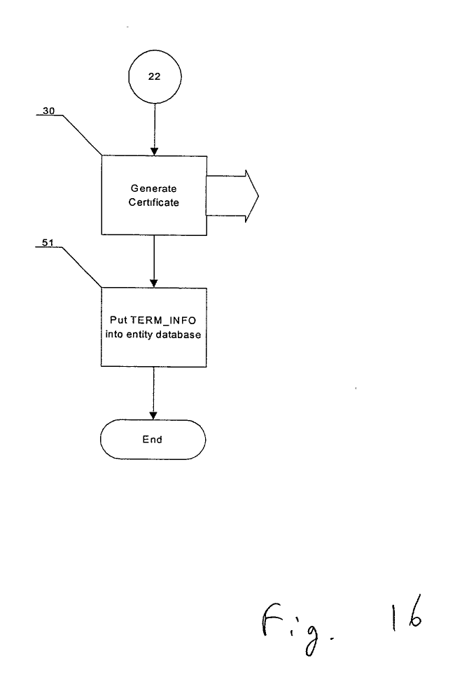

Terminal (TERM) entity is created 22 within SecEnv. See FIG. 16. First, an entity certificate is generated 30, as described previously. After that, TERM_INFO data structure is added 51 to the entity database. This structure consists of entity certificate, its network address, business information (such as bank account numbers) and possibly other relevant information.

LMD Creation (23)

License Management Device (LMD) entity is created 23 within SecEnv. See FIG. 17. First, an entity certificate is generated 30, as described previously. After that, LMD_INFO data structure is added 52 to the entity database. This structure consists of the entity certificate, its manufacturer information and possibly other relevant information.

Content Preparation

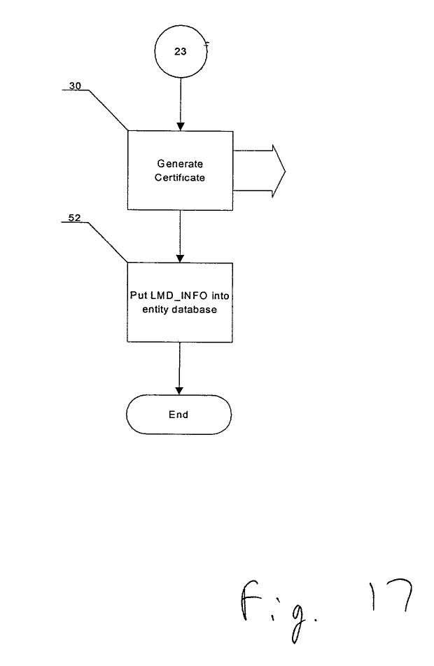

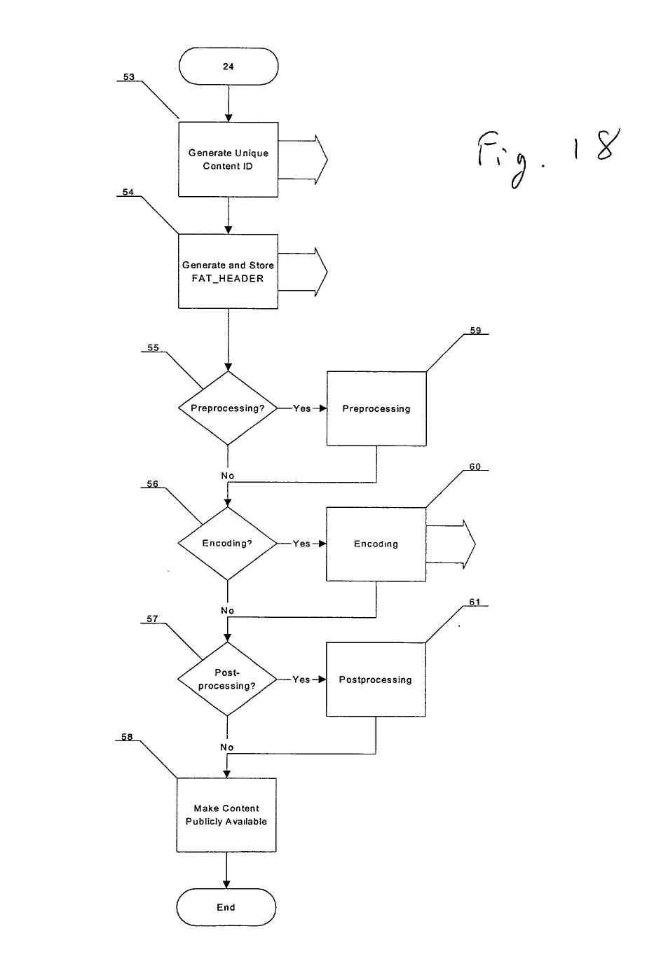

Content preparation overview is given in FIG. 18. First, Content Owner (CO) generates 53 a unique content identifier, for later identification of this particular content by other system entities. CO chooses a unique Content ID for this particular Content Owner (in random or some other fashion) and verifies 62 its availability. If available 63 this Content ID is allocated 64 for use and marked unavailable (in Business Rule Database). See FIG. 19.

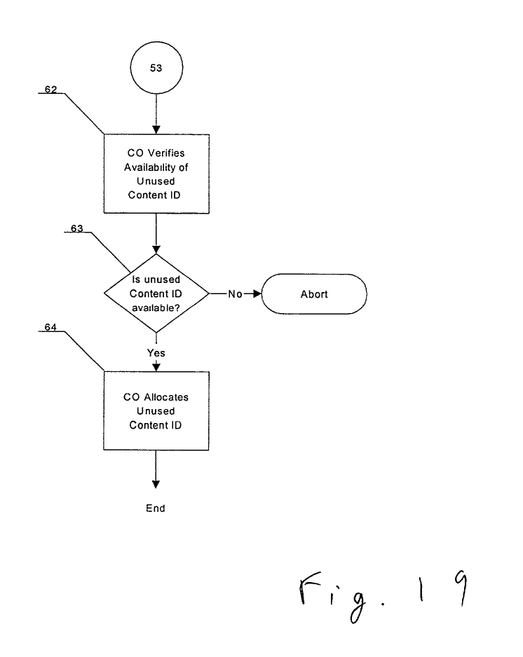

The next step is the generation of FAT_HEADER 54, a data structure containing information about content that is later embedded into the encoded content. The generation process is performed in several stages. First, the Content owner generates the FAT_HEADER structure and signs 65 it with COSigKey, thus creating a self signed FAT_HEADER structure consisting of Content Owner Identifier and Content Identifier. These identifications uniquely define every content available to the system. See FIG. 20.

FAT_HEADER is now sent to Transaction authority (TA) for processing 66. TA retrieves 67 CO_INFO from the entity database and checks 68 to see if this Content Owner is revoked. If not, CO signature on FAT_HEADER is verified 69. In case of revoked CO, TA sends a reject message. If a valid signature of non-revoked CO is found, TA signs FAT_HEADER and sends 70 it back to CO, together with TA's signature. TA now creates 71 CONTENT_INFO data structure consisting of FAT_HEADER and content description. Reference to this content is added 71 to the DISABLED table in the BRDB.

DISABLED table is a list of all content that is created and encoded but is not for sale yet because appropriate business rules are not defined yet. Its main purpose is to avoid race condition where content owner creates FAT_HEADER for new content, thereby allowing other distributors to locate that content, but business rules for that content are not created until next step. Making the content publicly available (58 in FIG. 18) creates the appropriate business rule if needed (if not, default business rule would apply) and removes content from DISABLED table.

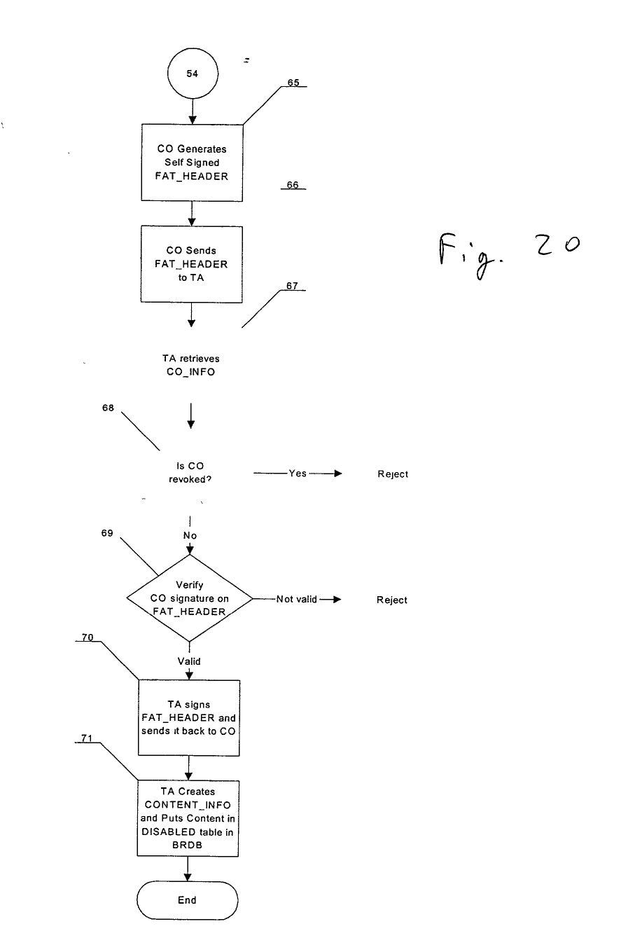

After having received the TA signed FAT_HEADER, CO performs preprocessing of content, if needed 55, 59. Encoding of content is the next step 56, 60, also optional. This process is performed in order to protect digital content with encryption. CO generates 72 random CONT_KEY used for encryption of content and stores 73 it with reference to appropriate CONT_ID into local, protected storage. Content data is then encrypted 74 and merged with FAT header to form an encoded digital content. See FIG. 21.

For content encryption, standard private key encryption is used. One key (called CONT_KEY) is used to encrypt content. The very same key is needed to decrypt content. That key is uniquely identified with two IDs: CO_ID that identifies content owner and CONT_ID that identifies particular content of CO. There can not be two CONT_KEYs with the same CONT_ID from the same CO (CO_ID).

Then, an optional step of content post processing is performed 57, 61, and CO makes 58 content publicly available.

Content Distribution

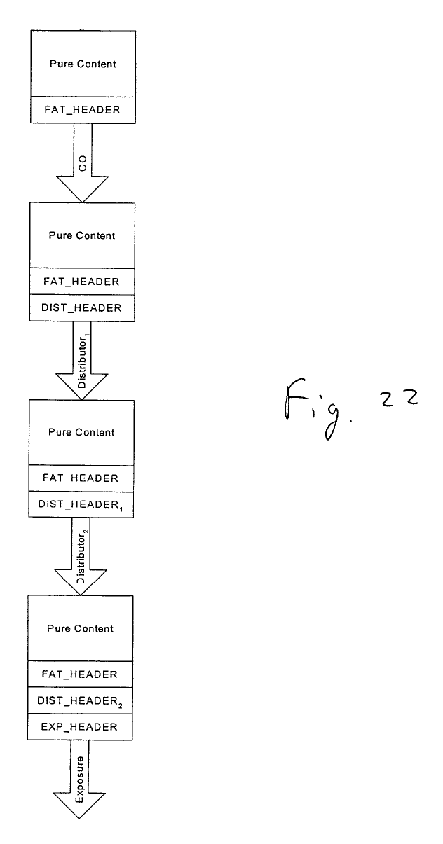

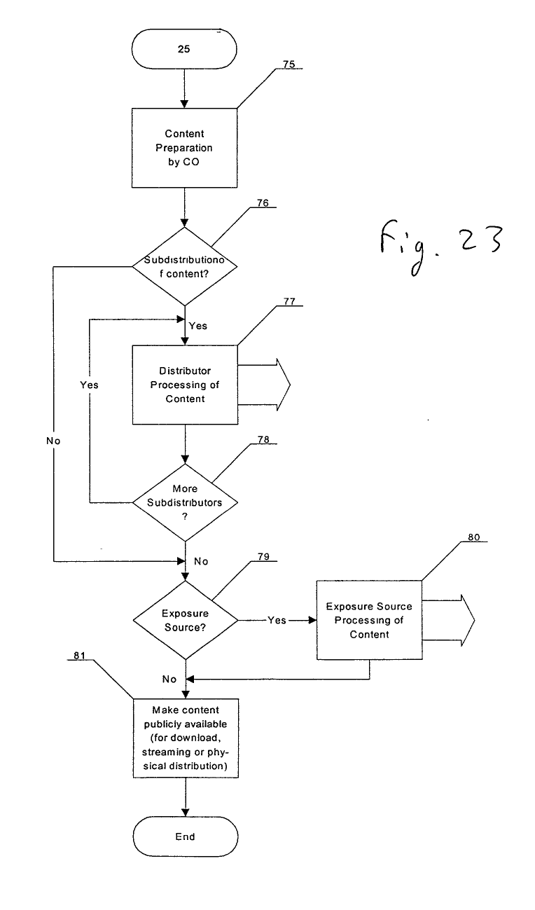

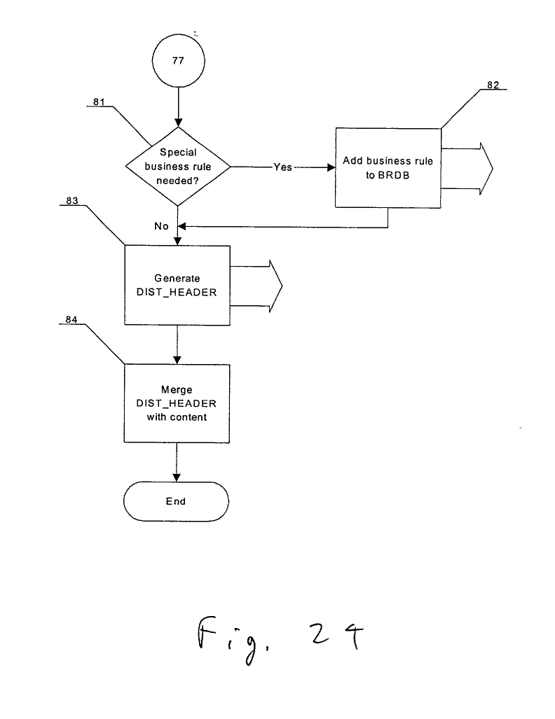

After content preparation is performed 75 by Content Owner, if allowed by business policies, sub distribution of content is performed 76. See FIG. 23. The distributor processes 77 content in accordance with it's own and content owner's business policies. If a special business rule is needed 81, distributor acts together with the TA, and adds 82 it to the database, after having it created 85, and accepted 86, 87 by the TA. See FIGS. 24 and 25.

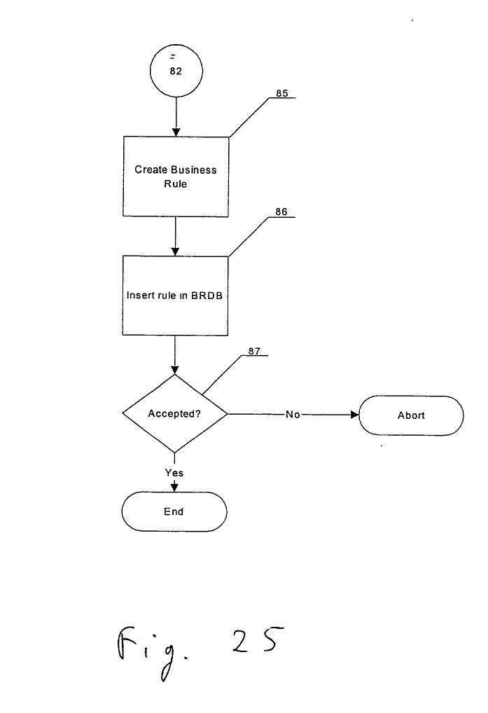

If all needed business rules are accepted, DIST_HEADER data structure can be generated 83 containing information about the distributor that is later on embedded into the encoded content. The generation process is performed in several stages. First, the distributor generates DIST_HEADER structure and signs 88 it with DistSigKey, thus creating a self signed DIST_HEADER structure consisting of Content Owner Identifier, Content Identifier and Distributor Identifier. DIST_HEADER is now sent to Transaction authority (TA) for processing 89. TA retrieves 90 DIST_INFO from the entity database and checks 91 if this Distributor is revoked. If not, the distributor signature on DIST_HEADER is verified 92. In case of a revoked distributor, TA sends a reject message. If a valid signature of non-revoked Distributor is found, TA checks 93 for consistency with BRDB and, if found consistent, signs 94 DIST_HEADER and sends 94 it back to Distributor, together with TA's signature. Distributor now can merge 84 DIST_HEADER with content to be distributed. See FIG. 26.

This process of sub distribution is repeated 78 if more sub distribution channels are acceptable with a given business policy.

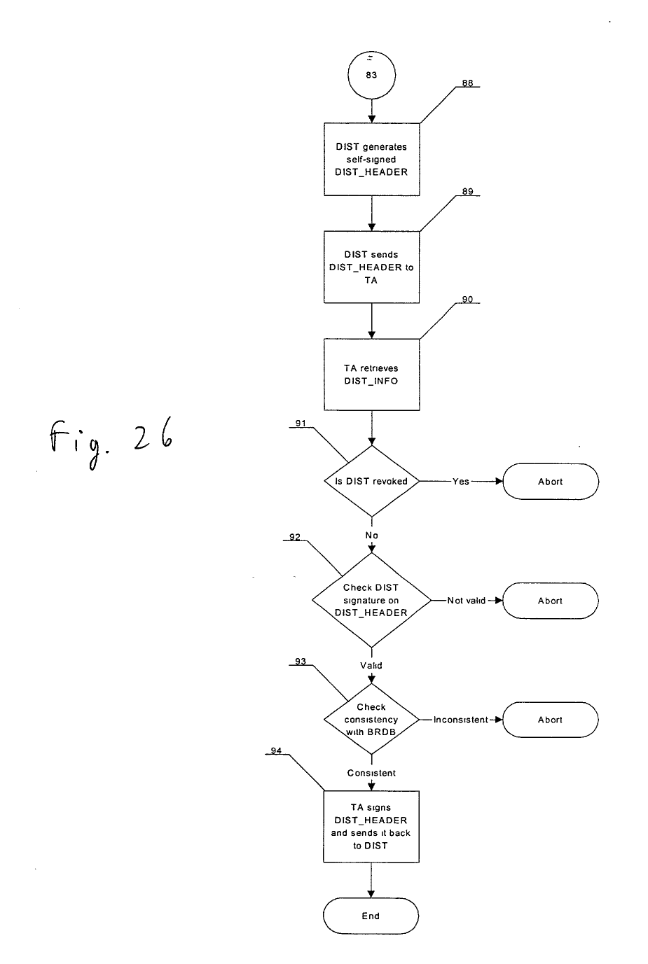

Exposure Source processing is the next link 79 in the chain of content distribution. If needed, Exposure Source processing 80 of content is performed. See FIG. 27. Exposure Source processes content in accordance with it's own, content owner's and sub distributors' business policies. If a special business rule is needed 95, Exposure Source acts together with the TA, and adds 82 it to the database, after having it created 85, and accepted 86, 87 by the TA. See FIG. 25.

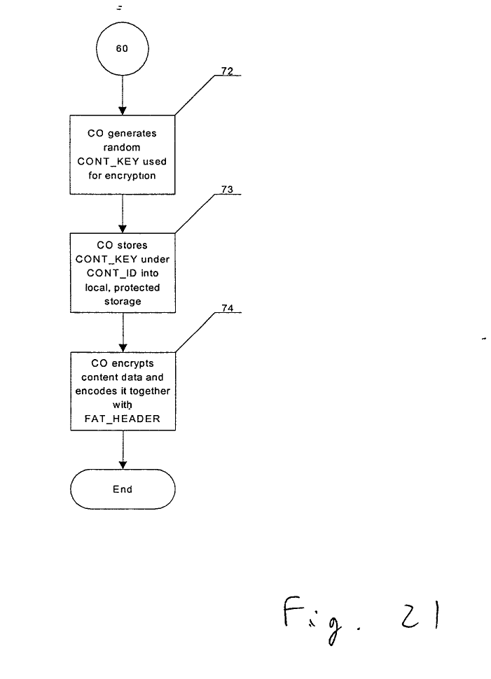

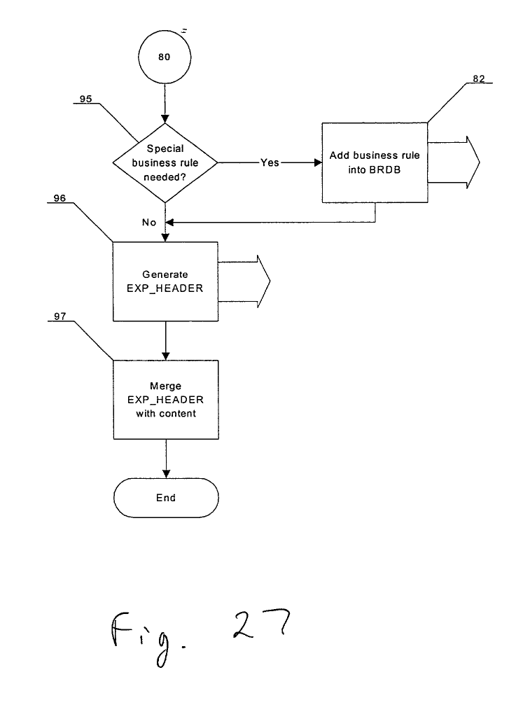

If all needed business rules are accepted, EXP_HEADER data structure can be generated 96 containing information about Exposure Source that is later on embedded into the encoded content. The generation process is performed in several stages as shown on FIG. 28. First, Exposure Source generates EXP_HEADER structure and signs 98 it with ExpSigKey, thus creating a self signed EXP_HEADER structure consisting of Content Owner Identifier, Content Identifier and Exposure Source identifier. EXP_HEADER is now sent to Transaction authority (TA) for processing 99. TA retrieves 100 EXP_INFO from the entity database and checks 101 if this Exposure Source is revoked. If not, Exposure Source signature on EXP_HEADER is verified 102. In case of a revoked Exposure Source, TA sends a reject message. If a valid signature of a non-revoked Exposure source is found, TA checks 103 for consistency with BRDB and if found consistent signs 104 EXP_HEADER and sends 104 it back to Exposure Source, together with TA's signature. Exposure Source now can merge 97 EXP_HEADER with content to be exposed. After performing all necessary steps, content is made 81 publicly available. The process of content distribution is summarized in FIG. 22.

License Purchase

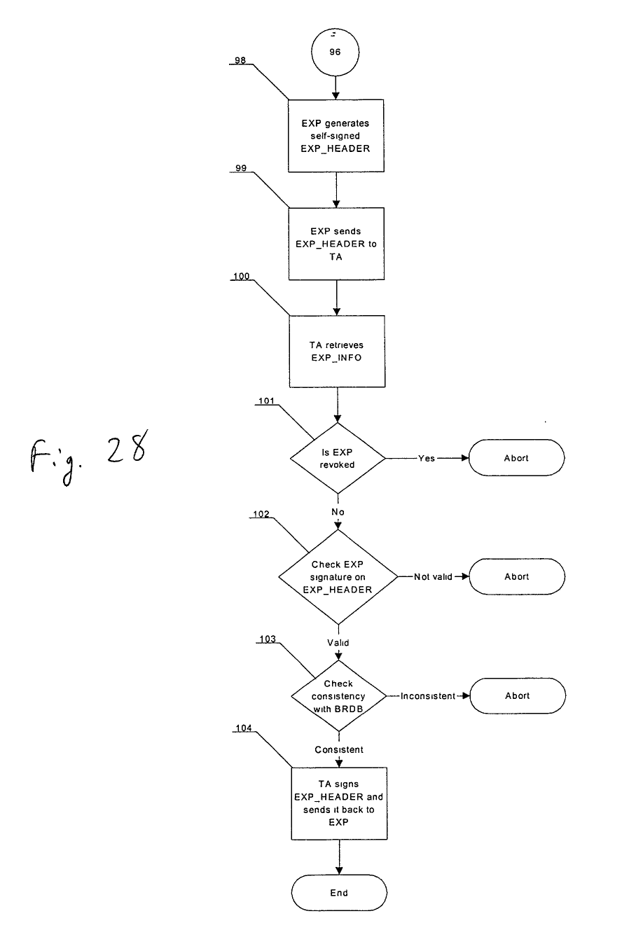

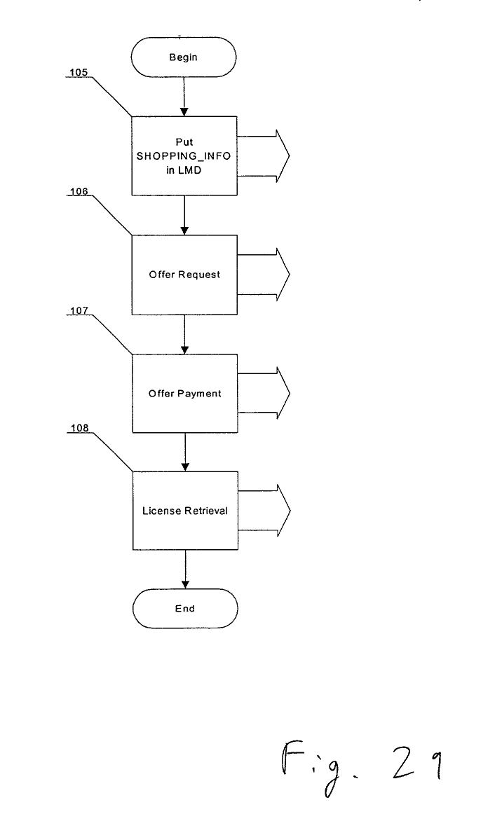

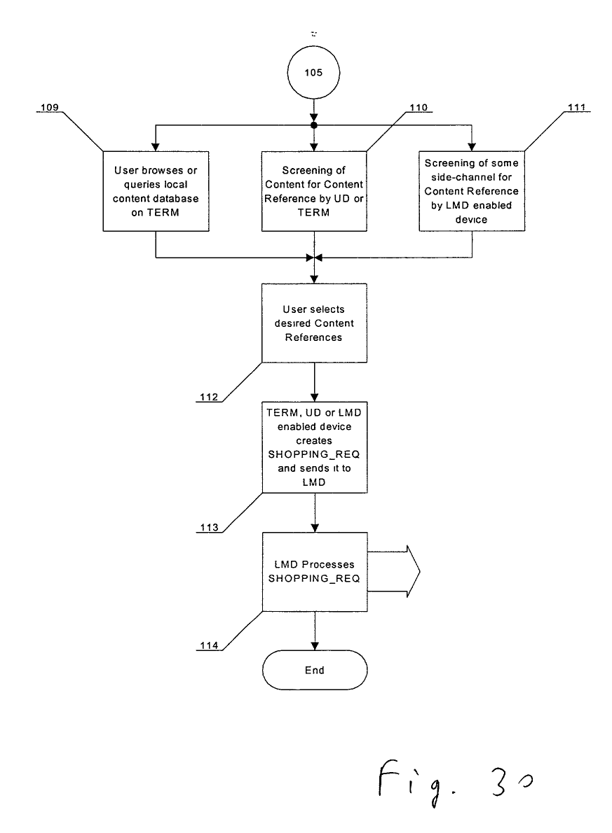

The process of license purchase begins with a user selecting content she wants and putting 105 its SHOPPING_INFO data structure into LMD's storage. See FIG. 29. Content references can be obtained by different means: browsing or querying local content databases on Terminal 109, screening of Content by Usage device or Terminal 110 or screening of some side-channel by LMD enabled device 111. See FIG. 30. After Content references are acquired, user selects desired content 112 and Terminal, Usage Device or LMD enabled device, creates SHOPPING_REQ and sends 113 it to the License Management Device. LMD then processes 114 this SHOPPING_REQ. This is done by first unpacking 115 it and then verifying 116 the signature part of FAT_HEADER. If found invalid, an abort message is sent and if signature is valid, processing is continued by examining 117 if DIST_HEADER exists. If DIST_HEADER exists, its signature is verified 118 and again, if invalid, an abort message is sent. If DIST_HEADER signature is valid, processing is continued by examining 119 if EXP_HEADER exists. If EXP_HEADER exists, its signature is verified 120 and again, if invalid, an abort message is sent. If EXP_HEADER has valid signature, the item described by these headers is stored 121 in Shopping Basket. See FIG. 31.

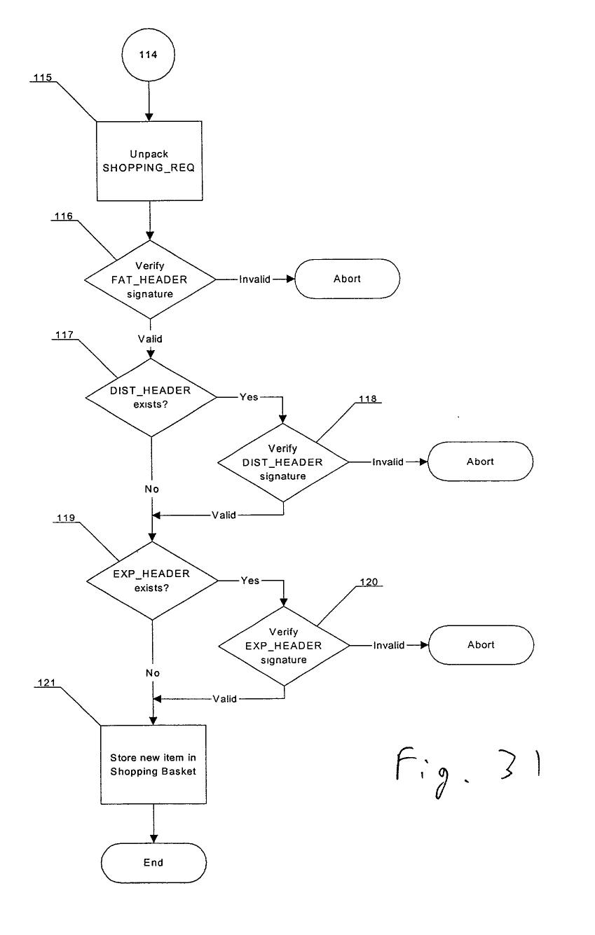

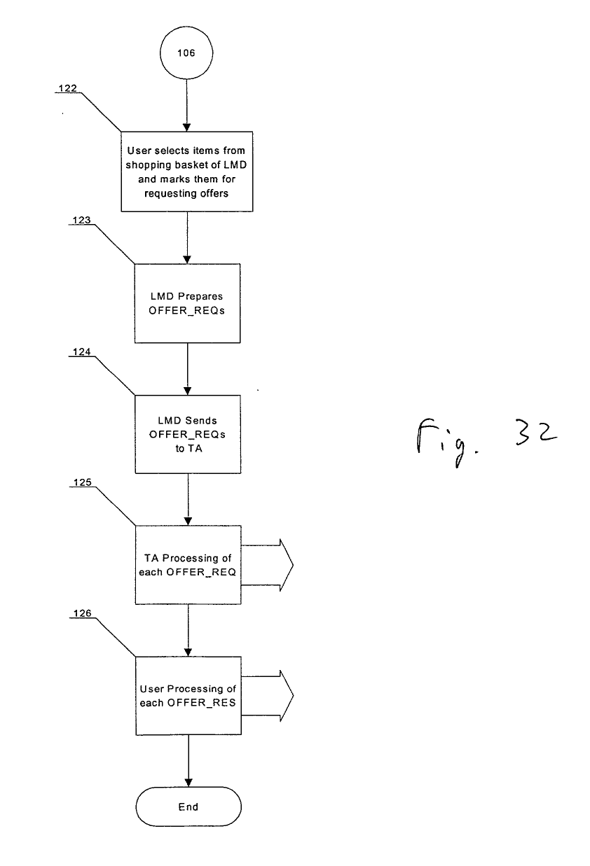

Then, an offer request is made 106 by LMD on behalf of the user. After the user selects 122 items from the Shopping Basket for which offers should be requested, LMD prepares 123 data structures. These structures are then sent 124 to the Transaction Authority. TA now processes 125 each OFFER_REQ. The first step is retrieving 127 LMD_INFO from the entity database. Then the TA checks 128 to see if that LMD is revoked. If found revoked, an abort message is sent but if LMD is not revoked, LMD signature on OFFER_REQ is checked 129. If this signature is invalid, again an abort message is sent. If valid signature is found, TA forwards 130 OFFER_REQ to Business Rule Database Manager for further processing and waits 131 for OFFER_RES response from BRDB Manager. See FIGS. 32 and 33.

The Business Rule Database Manager checks for existence 133 of Content Owner Identifier and for existence 134 of Content Identifier. If any of these identifiers does not exist, an abort message is sent. If checks 133 and 134 are successful, BRDB Manager checks to see if Content is disabled 135. Again, if disabled, an abort message is sent. If selected Content is not disabled, applicable value chains are found 136 in the Business Rule Database. If there are valid value chains 137, OFFERs are generated 138 for every value chain. In case there are no valid chains, an abort message is sent. All generated OFFERs are packed 139 into OFFER_RES and sent to Transaction Authority. See FIG. 34.

OFFER_REQ is a request that the user (that is LMD) creates when he/she wants to acquire CONT_KEY for protected content (CONT_KEY is needed to decrypt content). It consists of unique identifier of content (CO_ID and CONT_ID) and some additional data that describe the way user is accessing content (DIST_ID and EXP_ID) and the way user is accessing system service (TERM_ID). OFFER_REQ is LMD specific and therefore, LMD_ID is also included. LICENSE_TYPE field describes what kind of license (CONT_KEY+usage rights) user wishes to (e.g. time limited, number of playbacks, unlimited, etc.). LMD_ID is a unique identifier of License Management Device (e.g. smartcard).

All this is packed, encoded and digitally signed by LMD with LMDSigKey. Matching LMDVerKey is publicly available within the system (stored in Entity Database) and therefore, signature can be verified. Once the signature is verified, the LMD creates that OFFER_REQ.

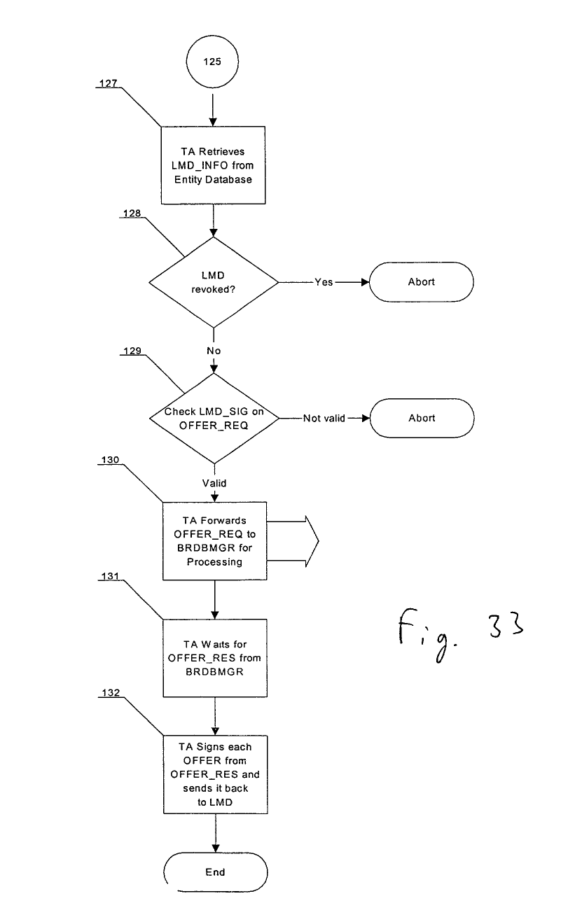

The OFFER generation sub process begins with generation 140 of unique OFFER_ID. Identifiers from OFFER_REQ (Content owner, Content, Distributor, Exposure Source, Terminal and License Management Device identifiers) are then stored 141 under this reference, together with Value Chain 142. From this Value Chain, price and expiration date are calculated 143, and the OFFER structure is created 144. See FIG. 35.

OFFER is data structure that is obtained as result of BRDB query for license and applicable business rules of previously described OFFER_REQ . It contains all data from OFFER_REQ and some additional data like price.

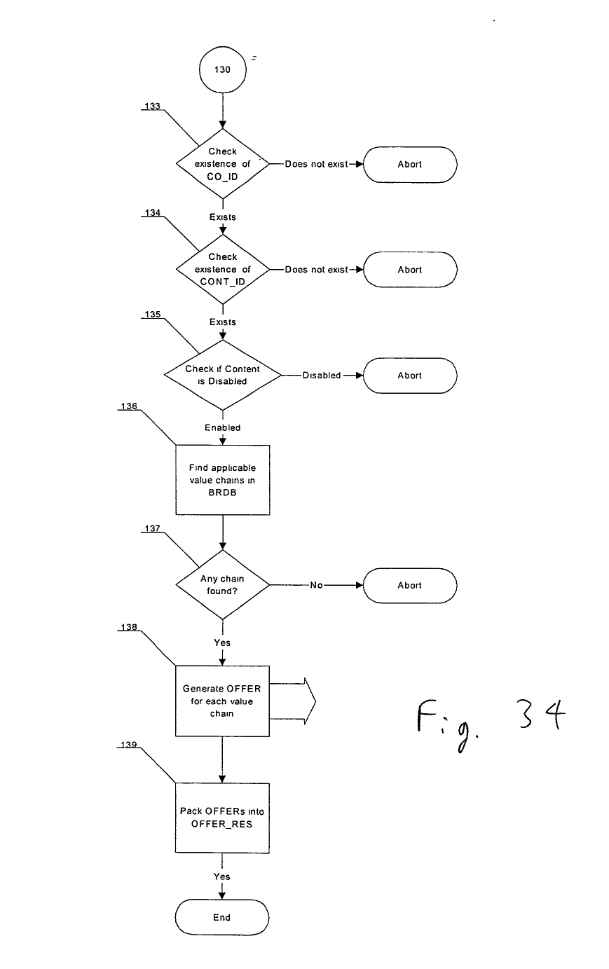

OFFER_RES is list of OFFERs. After having received OFFER_RES, Transaction Authority signs 132 each OFFER from OFFER_RES and sends it back to the License Management Device. Further processing 126 of OFFER_RES has to be done as shown in FIG. 36. The first step is for the Terminal to verify 145 TA signatures of all OFFERs contained in OFFER_RES. If all signatures are valid 146, Terminal displays 147 OFFERs to the user and prompts for selection and/or approval. If invalid signatures are found, Terminal informs 148 user about invalid OFFER_RES. If user has selected 149 some OFFERs, Terminal sends 150 them to the License Management Device. LMD then checks 151 Transaction Authority signatures on all received OFFERs. If all signatures are valid 152, OFFERs are stored 153 to the License management device.

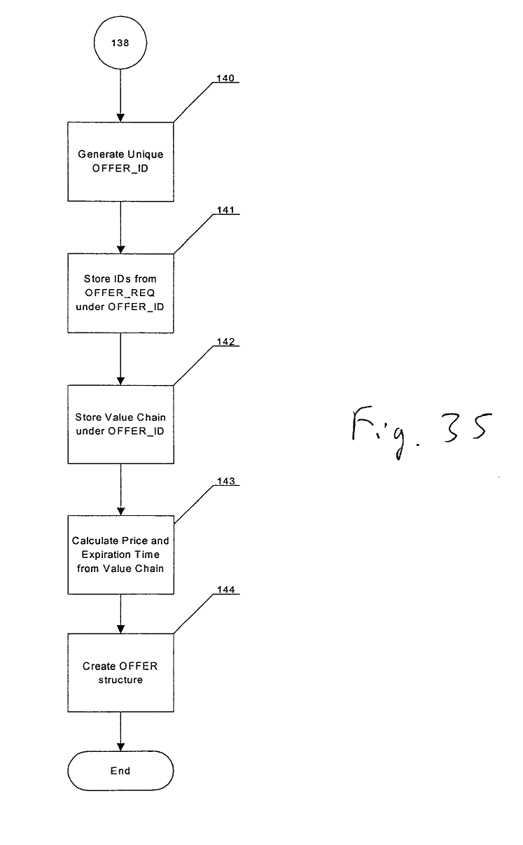

Offer payment (see FIG. 37) is the next step 107 in the license purchase process. First, the user selects 154 one or more OFFERs stored on the License Management Device. After that, the user initiates 155 payments with Financial Clearance authority (FC) for selected OFFERs and waits 156 for response. If payment was successful 157 LMD marks references matching paid OFFERs 158 for license retrieval. FC notifies Transaction Authority that the financial transaction was successful and TA forwards this information to the Business Rule Database Manager. If there are more OFFERs to be processed 159, the whole payment process is repeated.

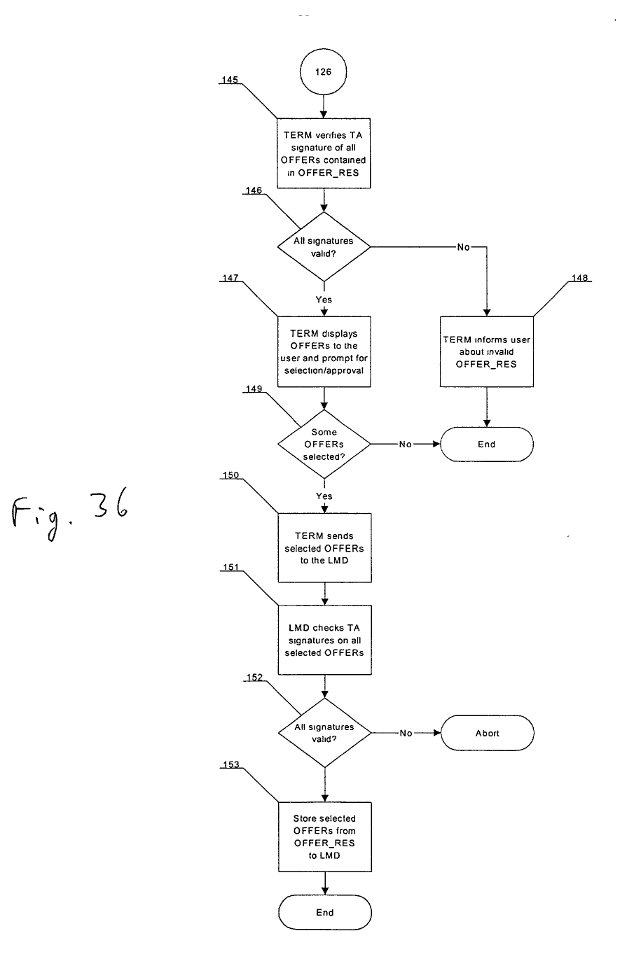

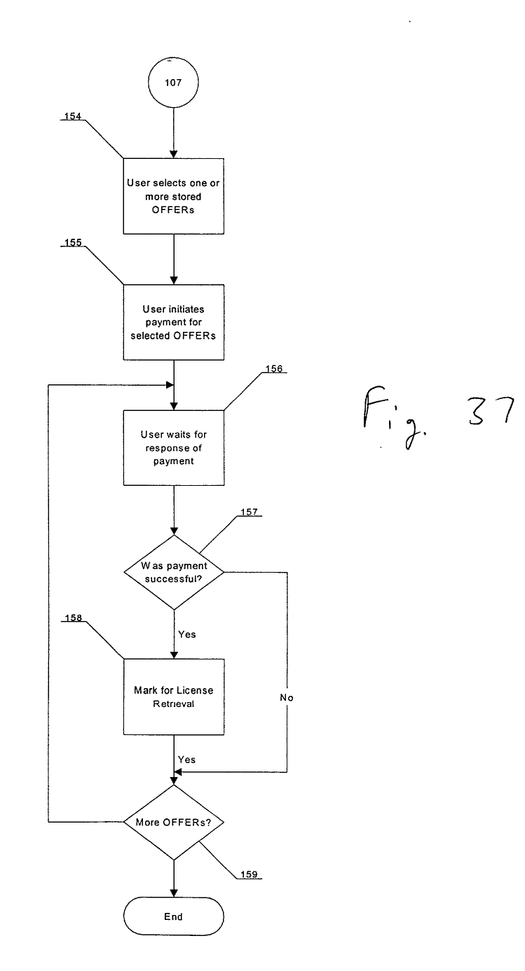

License retrieval (see FIGS. 38 and 39) follows 108 offer payment. If there are references marked for retrieval 160, License Management Device creates 161 LICENSE_REQ, using generated and stored 167 random nonce³ and encodes and signs 168 the created LICENSE_REQ. That data structure is then sent 162 to the Transaction authority for processing 163. ³Random nonce is a random (or pseudo random) number that is used in many cryptographic protocols.

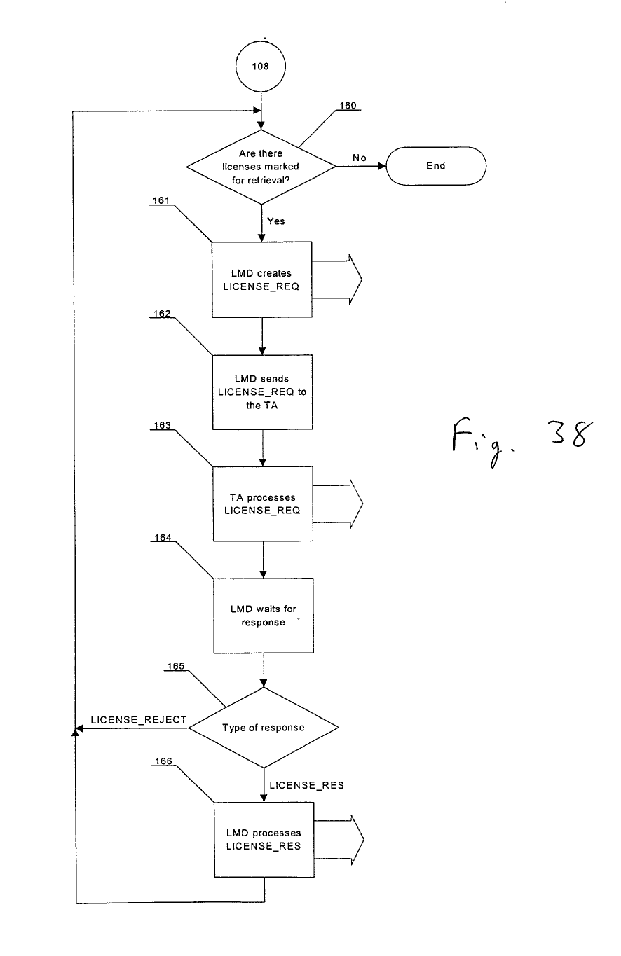

TA retrieves 169 LMD_INFO structure from the entity database and checks 170 if LMD_INFO exists. If not, a LICENSE_REJECT message is sent 171 to LMD. If LMD_INFO exists, License Management Device signature is checked 172 on the LICENSE_REQ data structure. If the signature is found invalid, another LICENSE_REJECT message is sent 173 to LMD. If License management device signature is valid, Business Rule Database Manager is queried 174 for the OFFER referred to in the LICENSE_REQ. If this OFFER exists 175, LMD_ID is valid and the offer is paid for, Transaction Authority retrieves 177 CO_INFO from entity database. If any of these conditions is not true, a further LICENSE_REJECT message is sent 176 to LMD. See FIG. 40.

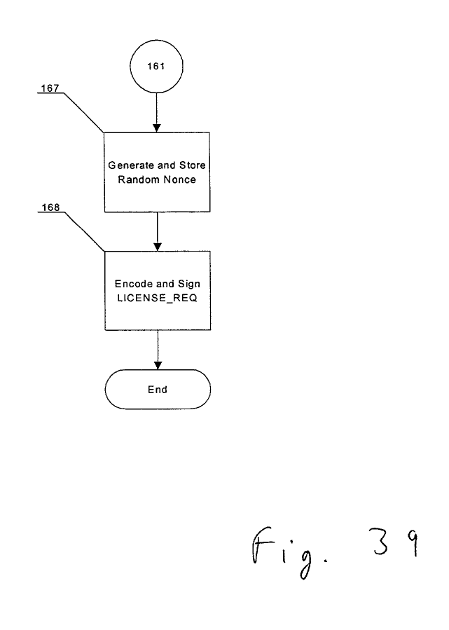

After retrieval 177 of CO_INFO, Transaction Authority sends 178 LICENSE_REQ, OFFER and LMD_INFO structures to the Content Owner. CO now processes LICENSE_REQ by first encrypting 180 the CONTENT_KEY with LMD public encryption key (LMDEncKey) retrieved from LMD_INFO. USAGE_RIGHTS are then copied 181 from the OFFER and LICENSE_RES is created and sent 182 back to the Transaction Authority. After receiving LICENSE_RES, Transaction Authority signs 179 it and sends it back to The License Management Device via Terminal. LMDEncKey is public encryption key of LMD. USAGE_RIGHTS is e.g. right to playback content 10 times, or right to playback content for 10 days, or right to transfer content from one LMD to another, etc. See FIG. 41.

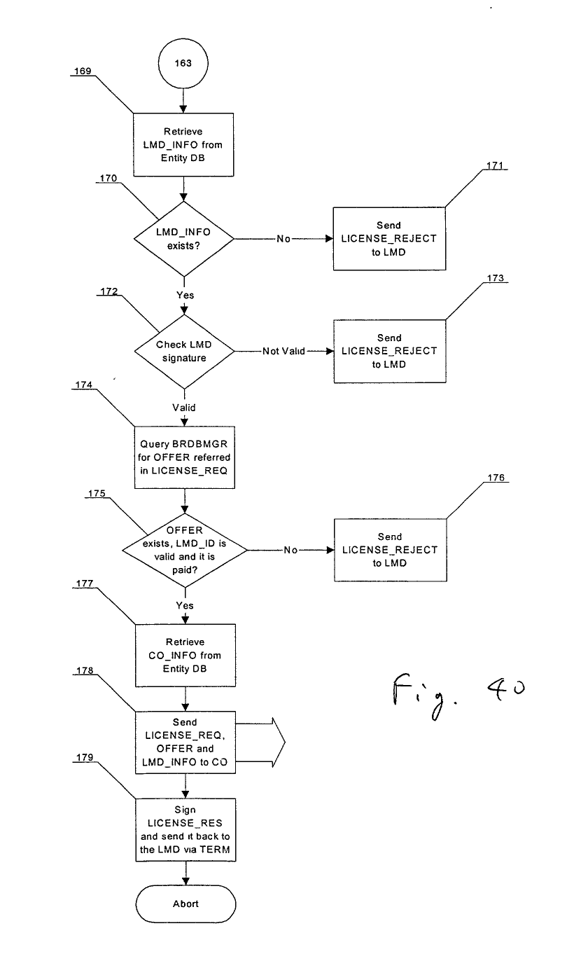

License Management Device, after waiting 164 for response from TA, depending 165 on the type of response continues the process. If response was LICENSE_REJECT, further processing is canceled and retrieval of next license is started. If the type of TA response was LICENSE_RES, LMD processes 166 this response. First, Transaction authority signature is checked 183, and matching LICENSE_REQ is searched 184 for. (In this context matching means that identifiers and stored nonce value should be the same in LICENSE_REQ and LICENSE_RES.) If matching LICENSE_REQ is found, CONTENT_KEY is decrypted 185 using LMDDecKey and stored 186 together with Usage Rights. LICENSE_REQ for now retrieved license is deleted 187. See FIG. 42. LMDDecKey is private decryption key of LMD.

With this, the license retrieval process is completed.

Content Usage

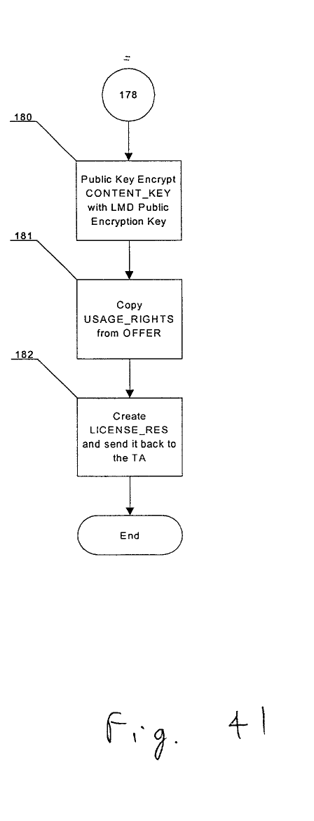

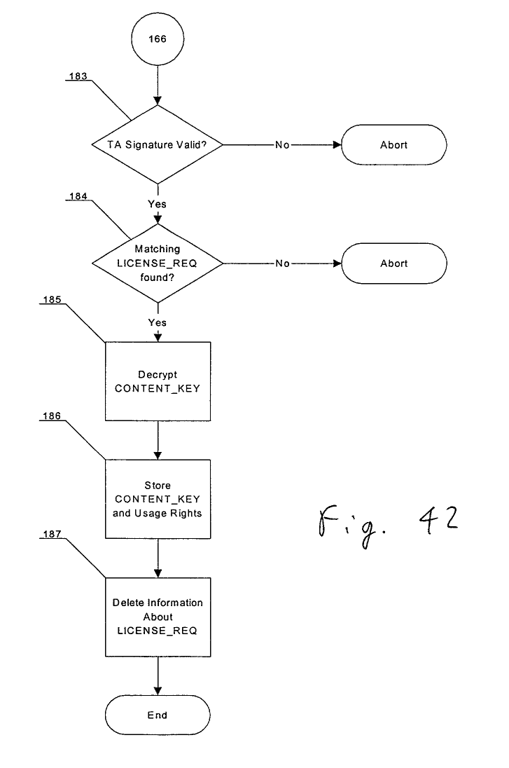

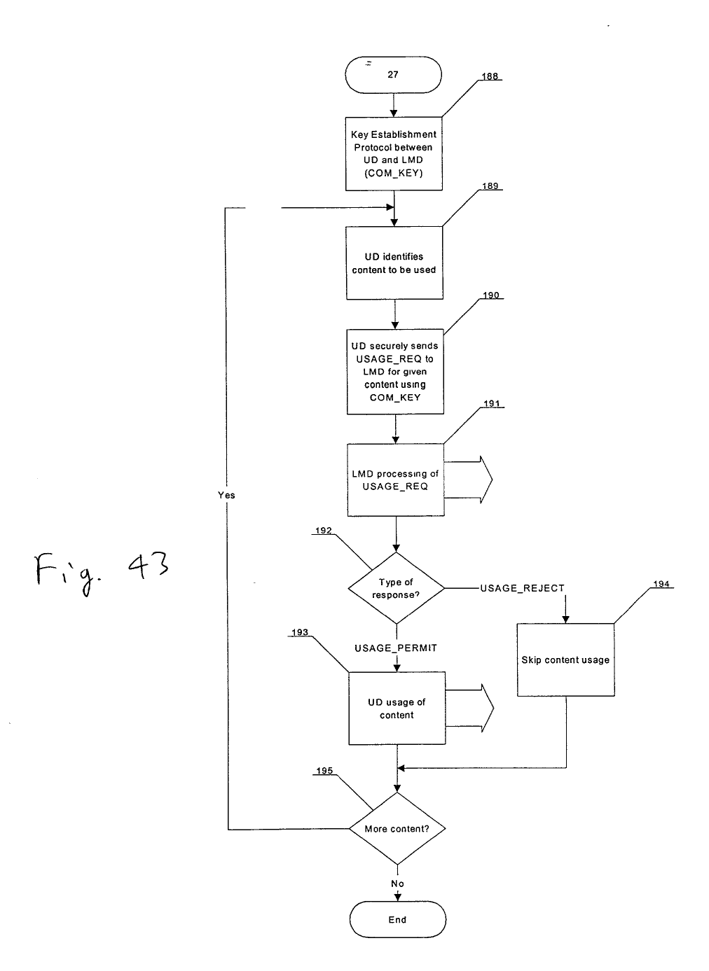

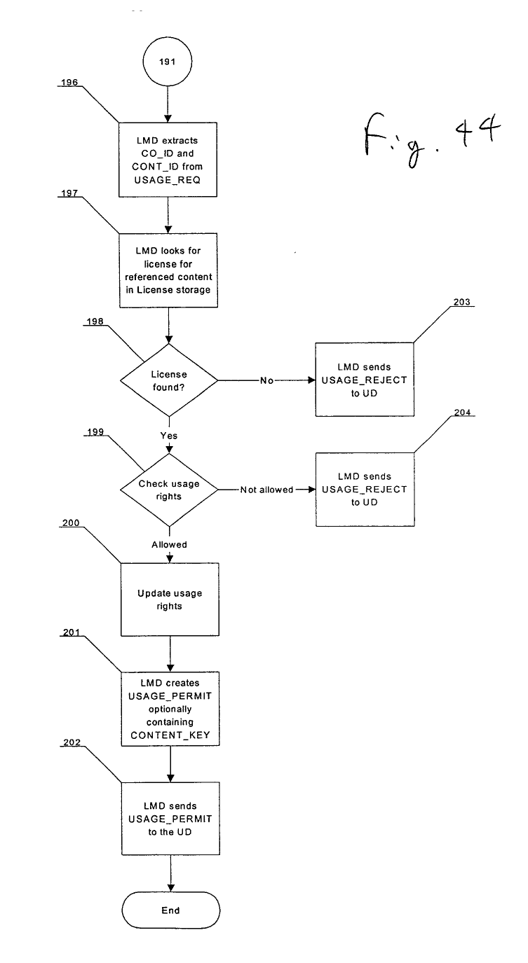

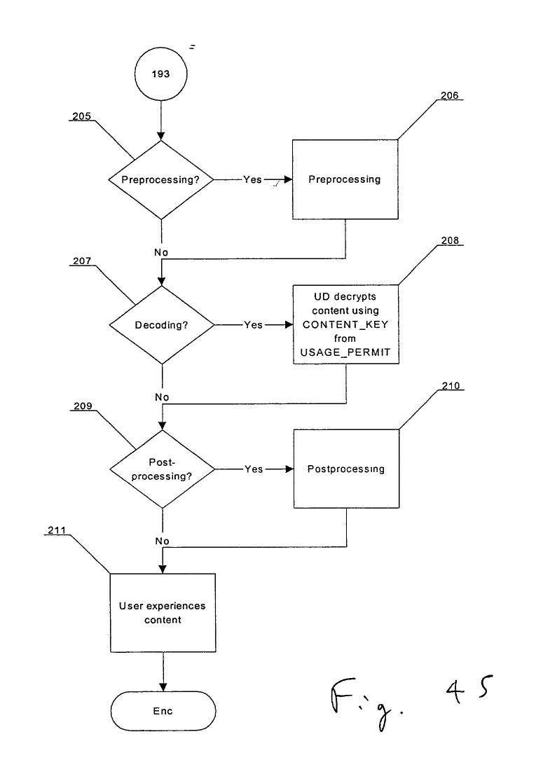

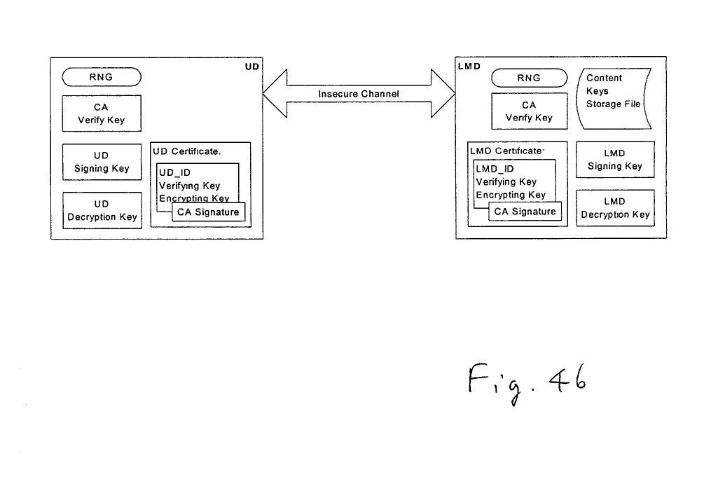

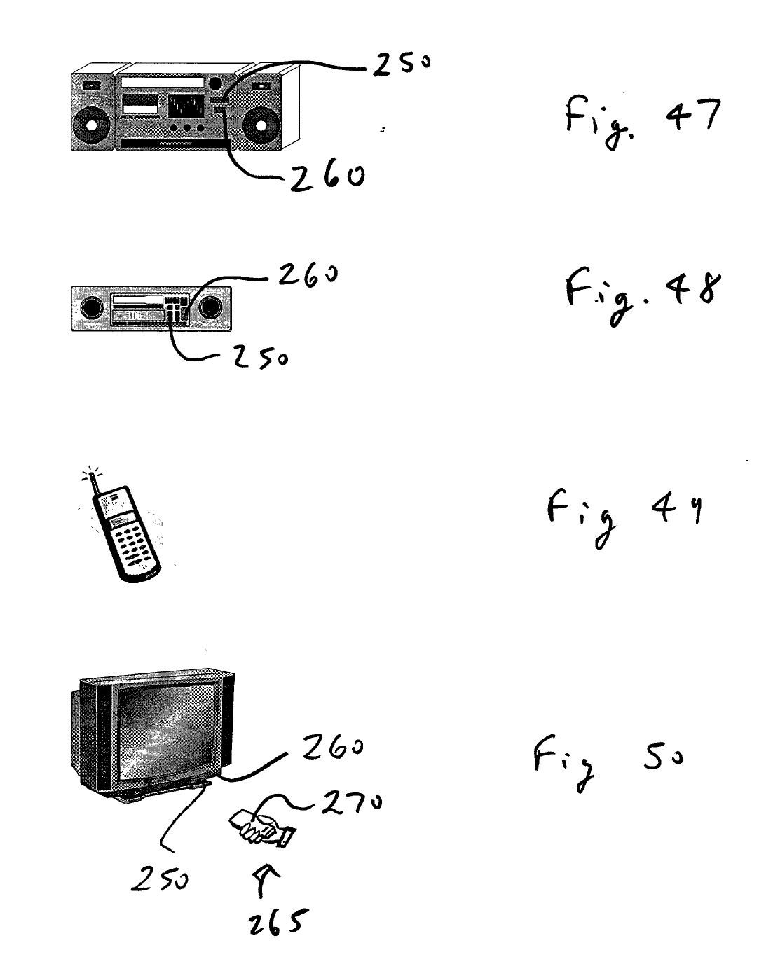

Content usage (FIG. 43) is the central part 27 of the current invention's operation. The user first needs to initiate this process by requesting playback or other forms of content usage. Then, one of the key establishment protocols (e.g. X.509 Secure Authentication Protocol⁴) is executed 188 between Usage Device and License Management Device. This protocol is used to establish COM_KEY, a symmetric encryption key used for securing of the communication between LMD and UD. Usage Device now identifies 189 content to be used and sends 190 USAGE_REQ to LMD for given content in a secure fashion. After receiving it, License Management Device processes 191 said USAGE_REQ by first extracting 196 Content owner and Content Identifiers. LMD now looks 197 for referenced content license in the license storage. If requested license is not found 198, License Management Device sends 203 a USAGE_REJECT message to the Usage Device. If a license is found, USAGE_RIGHTS are checked 199 and if usage of said content is not allowed, again, a USAGE_REJECT message is sent 204 to the Usage Device. If stored USAGE_RIGHTS allow use of content, the Rights are updated 200 if necessary and a USAGE_PERMIT message is created 201, optionally containing a CONTENT_KEY. License Management Device now sends 202 a USAGE_PERMIT massage to the Usage Device. See FIGS. 43 and 44. ⁴X.509 Secure Authentication Protocol is cryptographic protocol usedto establish secure, authenticated connection over an insecure channel between two parties.

After waiting 192 for response, its type is checked by the Usage Device. If the type of response was USAGE_REJECT, usage of the content is skipped 194. If the received response was USAGE_PERMIT, Usage Device can now perform necessary actions 193 for use of the content. These actions are optionally preprocessing 205, 206 of content, also optional decryption 207, 208 of content using the CONTENT_KEY extracted from the USAGE_PERMIT. Finally, optional post processing of content is performed 209, 210. User can now experience the 211 content. See FIG. 45.

LMD and UD communication requirements are summarized on FIG. 46 and below.

Usage Device Requirements:

CA Verify KeyCard—Globally shared CA public key needed for verification of certificates

UD Signing KeyCard—Secret private key used for digital signatures

UD Decryption KeyCard—Secret private key used for public key decryption

UD Certificate—Certificate containing UD public keys used for digital signature verification and public key encryption, signed by CA

RNG—Random number generator in UD can be replaced with non-volatile counter.

Requirement on UD RNG is generation of non-repeating values only. The values do not need to be unpredictable and have any statistical properties.

License Management Device:

CA Verify KeyCard—Globally shared CA public key needed for verification of certificates

LMD Signing KeyCard—Secret private key used for digital signatures

LMD Decryption KeyCard—Secret private key used for public key decryption

LMD Certificate—Certificate containing LMD public keys used for digital signature verification and public key encryption, signed by CA

RNG—Random number generator. It must be cryptographically strong and is used for generation of session keys used to encrypt sensitive information.

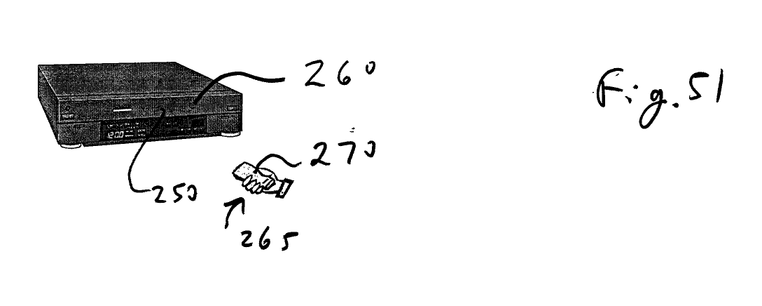

Examples of system-compatible devices are shown in FIGS. 47-51. Only audio and video devices are illustrated on FIGS. 47-51. Those familiar with the art to which this invention pertains will realize that the technology of this invention can be extrapolated to other forms of digital content. Each device illustrated on FIGS. 47-51 includes a KeyCard slot 250 and a “Like” button 260 or equivalent. Devices with remote controls 265 have an additional “Like” button 260 on the remote 265.

When the audio/video plays, content information is transmitted together with the audio/video data. Content information can be transmitted by RDS (as the simplest method already available) or sideband technologies. If the device includes any type of display some text info about the content (e.g. artist and title) can also be presented to the listener/viewer.

If the listener/viewer likes the content he/she can instantly memorize it for future purchase by simply pressing ‘Like’ pushbutton. All other necessary actions (storing this information on the KeyCard) are performed automatically by the system.

There are several possible ways this can be accomplished. In the simplest procedure, if the device features a slot for a storage medium and the storage medium is inserted, the device stores content information to a “shopping basket” on the storage medium. If the storage medium is not inserted content information is stored internally. When the storage medium is next inserted, all memorized information in the shopping basket is transmitted to storage medium.

If the device does not feature a slot for a storage medium, minimum system requirements are that it has special ‘Like’ pushbutton (or emulates this function by combination of existing pushbuttons) and that it has some NV internal memory. After ‘Like’ pushbutton is pressed content information is stored to internal memory. The user can later transmit this data to other system compatible devices by means of IR transmission, cable connection, DTMF signaling, or similar method. The receiver device can be a slot with a storage device or another device featuring a storage device or another device capable of memorizing content information.

To see how the system works, imagine a person who uses the computer at work and at home daily. First, he visited one of many system-enabled web sites and downloaded the player interface. During the download he was asked to enter some personal information and a credit card number. Later, while working, the Internet radio station he was listening to played his favorite tune. He clicked on the small interface “Like” button in the corner of his screen. The title, artist and record labels information for the song appeared and he was presented with a special offer for this song if purchased within a few minutes. The user entered his secret PIN and within seconds he received the license to play the song he had selected. Once he downloaded the song, he was able to listen to it any time. Together with the song, he received a special coupon that he could use towards his next purchase.

Now imagine another user who is not a computer user. She receives magazines with free CDs containing many new groups and individual artists in the new secured format. Although she has a new system compatible audio, she could not listen to those songs since she did not have a valid license to play them. Licenses could be obtained online but she did not have a computer at home nor she understood how to use it. She purchased licenses to listen to the free CDs at her local music store through a simple and fast, in-store procedure.

The system and method for secure electronic rights management, secure transaction management and content distribution 5 has been described with reference to a particular embodiment. Other modifications and enhancements can be made without departing from the spirit and scope of the claims that follow.

What is claimed is:

1. A system for secure electronics rights management, secure transaction management and secure content distribution comprising:
a. a card means for storing personal license information of a user in encrypted form;
b. a remote storage means for storing content in encrypted form; said encryption designed to ensure that said content on said remote storage means can be experienced only by said user;
c. a terminal means for downloading said personal license information to said card means upon request and payment from said user;
d. a playback means for accepting said card means and said remote storage means, and allowing said user to experience said content in accordance with the terms of said personal license; and
e. a secure transaction server means for: securely receiving said content from a distributor, securely storing said content, securely accepting said request and said payment, distributing said content to said user, managing said personal license information, and securely downloading said personal license information to said card means.

2. A system as claimed in claim 1 in which said distributor is the owner of said content.

3. A system as claimed in claim 1 in which said card means contains a microchip.

4. A system as claimed in claim 1 in which said remote storage means is a compact disk (CD).

5. A system as claimed in claim 1 in which said remote storage means is a memory card.

6. A system as claimed in claim 1 in which said remote storage means is a digital video disk (DVD).

7. A system as claimed in claim 1 in which said remote storage means is a hard drive.

8. A system as claimed in claim 1 in which said terminal means is a PC, attached to the Internet and with and attached reader/writer for said card means.

9. A system as claimed in claim 1 further including a memorizing means for memorizing experienced but unlicensed content for future license; said memorizing means being incorporated in said playback means.

10. A system as claimed in claim 1 in which said playback means is a radio.

11. A system as claimed in claim 1 in which said playback means is a television.

12. A system as claimed in claim 1 in which said playback means is a portable music player.

13. A system as claimed in claim 1 in which said playback means is television signal decoder (set top box).

14. A system as claimed in claim 1 in which said playback means is a cellular phone.

15. A method for secure electronics rights management, secure transaction management and secure content distribution comprising the steps of:
a. providing a memory card with embedded microchip adapted for storing personal license information of a user in encrypted form;
b. providing a storage medium for storing content in encrypted form;
c. providing a terminal for downloading said personal license information to said memory card upon request and payment from said user;
d. providing a playback device adapted for accepting said memory card and said storage medium, and playing back said content in accordance with the terms of said personal license;
e. providing a secure transaction server;
f. securely receiving said content from a content provider to said secure transaction server;
g. securely storing said content on said transaction server;
h. securely accepting said request and said payment at said secure transaction server;
i. distributing said content to said user from said secure transaction server encrypted so that said content can only be experienced by said user;
j. managing said personal license information in said secure transaction server; and
k. securely downloading said personal license information from said secure transaction server to said memory card via said terminal.

16. A method as claimed in claim 15 further comprising the step of preprocessing said content by:
a. generating a unique content identifier;
b. generating a first data structure (FAT_HEADER) containing information about said content;
c. generating a second data structure (DIST_HEADER) containing information about distribution of said content;
d. incorporating said unique content identifier, said first data structure and said second data structure into said content; and
e. optionally encoding said content.

17. A method as claimed in claim 15 in which the step of providing a terminal further comprises the steps of:
a. providing a reader/writer for said memory card; and
b. attaching said reader/writer to a PC, attached to the Internet.

18. A method as claimed in claim 15 further comprising the step of providing a memorizing means for memorizing experienced but unlicensed content for future license; said memorizing means being incorporated in said playback device.

19. A method as claimed in claim 15 in which the step of distributing is accomplished via the Internet.

20. A method as claimed in claim 15 in which the step of distributing further comprizes the steps of:
a. storing said content on an appropriate storage medium; and
b. mailing said storage medium to said user.
